(19) United States
(12) Patent Application Publication
(10) Pub. No.: US 2025/0158497 A1
(43) Pub. Date: May 15, 2025

(54) INTRINSICALLY ADAPTING VARIABLE GENERATORS AND MOTORS

(71) Applicant: NextPower360 Co., Leicester, NC (US)

(72) Inventor: Benedetto Anthony IACOVELLI, Leicester, NC (US)

(21) Appl. No.: 18/948,320

(22) Filed: Nov. 14, 2024

Related U.S. Application Data
(60) Provisional application No. 63/598,856, filed on Nov. 14, 2023.

(51) Int. Cl. H02K 16/00; H02K 1/27; H02K 13/00

(52) U.S. Cl. CPC H02K 16/00; H02K 1/27; H02K 13/00

(57) ABSTRACT

An electromagnetic armature including, electrically connected rotor layers and stator layers made of magnetically permeable material. The rotor layers are provided radially between adjacent ones of the stator layers. The rotor layers and the stator layers are integrally connected to rotate together about a central axis of the electromagnetic armature.

### CROSS-REFERENCE TO RELATED APPLICATIONS

The present application claims domestic priority to 63/598,856, filed on Nov. 14, 2023, and is related to Ser. No. 18/232,959, filed on Aug. 11, 2023, which claims domestic priority to 63/373,582, filed Aug. 26, 2022; 63/467,843, filed May 19, 2023; and 63/467,850, filed May 19, 2023. The entire contents of the above applications are hereby incorporated herein by reference.

### BACKGROUND OF THE INVENTION

### 1. Field of the Invention

The present invention relates to novel structures and systems for improvements to generators and motors. More specifically, the present invention relates to generators and motors that are able to be made smaller, more powerful, and more efficient and able to function better in variable input and operating conditions, such as gusty and widely varying wind speeds, or in changing load and rpm operating conditions of a motor vehicle. These improvements have profound ramifications for power generation (especially in wind power generation) and electric vehicle industries. In power generation, the example embodiments of the present invention are able to harvest more power from a variable input, such as wind, while being smaller, lighter, and more robust. In the electric vehicle industry, the generators and motors of example embodiments of the present invention achieve greater efficiency, range, power density, and improved regenerative braking capacity.

### 2. Description of the Related Art

With the advent of wind power, engineers took the prior art's constant input/constant RPM requiring devices, and put them on top of a tower, adding one of various kinds of turbines to the input shaft. The wind spun the turbine and some electricity was produced, so this was considered a success. However, the input from wind is so highly variable it is the exact opposite of the constant steady input required by the early designs, so they fail to harvest a large portion of the available energy.

In general, a generator faced with the above input would produce little to no power for a significant part of the time that the wind is at lower speeds and would waste most of the available energy when the wind is blowing faster than needed for the ideal RPM. There have been improvements to wind and other generators to improve their function with a variable input. The vast majority are directed to finding ways to waste the energy, sacrificing harvesting efficiency to keep the generator from over-spinning and to match the grid's frequency. A reasonable estimate is that wind generators can waste up to 60 percent of the harvestable energy. Thus, currently available generators can only be feasibly sited in expensive, faraway places with the best wind, such as offshore or on top of a mountain, thus sapping more power due to line loss and limiting feasible sighting options.

In early disk motors, it was determined that, because the outer rim of the metal disk travels the furthest and the fastest, transecting the most magnetic field lines per second, it was the part of the disk that induced the most current. Therefore, making this outer edge thicker caused more metal to participate in the strongest region of current production, increasing the output.

This led to the metal disk being replaced by a drum shaped rotor, which can be thought of as a disk with a very tall/thick outer rim. The magnets then had to be changed to an inner and outer concentric cylinder magnets creating a radial field between them. It was within this radial field space that the rotor drum rotated.

The rotor drum in all generator/motor incumbent designs needs to be fairly thick to confer the structural integrity to not expand centrifugally, warp, flex or vibrate. There also needs to be a space on each side of the rapidly rotating drum's walls to keep it from rubbing on the stator/magnets. This space needs to be wide enough to handle thermal expansion of the parts. The stator magnets need to be powerful enough to provide a strong enough field to cross the airspaces, penetrate the rotor and still be strong enough to provide a close to the maximal EMF necessitated by the rotor thickness. This meant the magnets needed to be fairly thick also. So the entire apparatus of current generators and historical drum homopolar motors function only because the electrical generating parts are relatively thick and heavy.

### SUMMARY OF THE INVENTION

To overcome the problems described above, example embodiments of the present invention provide new generator systems and structures that instantly and constantly adapt to the variability of the wind. Conceivably, example embodiments of the present invention can harvest up to about 2½ times as much power as the conventional designs, depending upon the wind pattern. More importantly to the wind power industry, being so much more efficient, generators according to example embodiments of the present invention can be sited in orders of magnitude more places, including closer to where the power is needed.

According to an example embodiment of the present invention, a dynamo electric machine includes a rotor drum defined by a complex, multi-part, solid, heavy conductive cylinder.

An example embodiment of the present invention includes an electromagnetic armature including electrically connected rotor layers, and stator layers made of magnetically permeable material. The rotor layers are provided radially between adjacent ones of the stator layers, and the rotor layers and the stator layers are integrally connected to rotate together about a central axis of the electromagnetic armature.

Another example embodiment of the present invention includes a dynamoelectric machine including a stator, a rotor, a shaft, and current collectors. The stator includes multiple concentrically arranged cylindrical stator layers. The rotor includes multiple concentrically arranged cylindrical rotor layers. Each of the multiple concentrically arranged cylindrical rotor layers is located between adjacent pairs of the concentrically arranged cylindrical stator layers. The stator and the rotor are affixed to one another and are rotatable together about a central axis of the shaft, and each of the concentrically arranged cylindrical stator layers have identical magnetic polarities.

The above and other features, elements, characteristics, steps, and advantages of the present invention will become more apparent from the following detailed description of example embodiments of the present invention with reference to the attached drawings.

### BRIEF DESCRIPTION OF THE DRAWINGS

FIG. 1 shows a side cross-section view of a dual rotor/triple layer stator configuration according to an example embodiment of the present invention.

FIG. 2 shows a cross section of a dynamoelectric machine corresponding to an example embodiment of the present invention.

FIG. 3 an exploded perspective view of the dynamoelectric machine shown in FIG. 2.

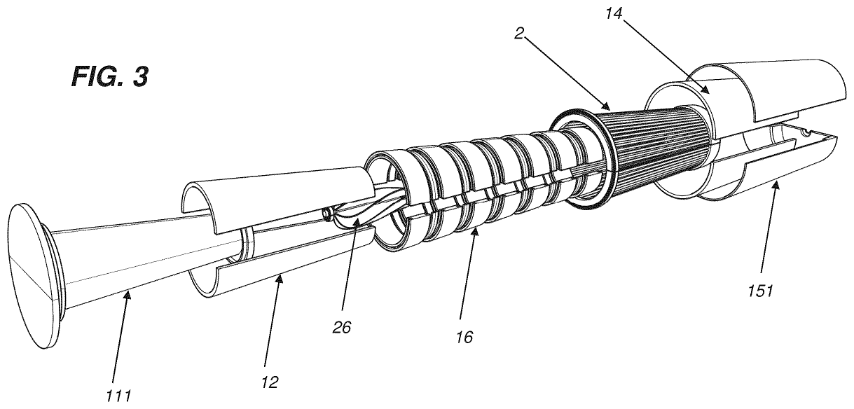

FIG. 4 shows a cross section of a dynamoelectric machine corresponding to another example embodiment of the present invention.

FIG. 5 shows another cross section of a dynamoelectric machine corresponding to another example embodiment of the present invention.

FIG. 6 is a cross-section diagram of an example embodiment of the present invention which includes a dual rotor and tri-stator configuration with hybrid electro/permanent magnets on the inner and outer stator and only permanent magnets on the middle stator. Permanent magnets in the drawing are preferably adjacent conical frustum segments that are on the rotor side of the permanent magnets with the inner and outer stator electromagnets on the yoke side of the stators.

FIG. 7 shows examples of rotor configurations according to example embodiments of the present invention.

FIG. 8 shows a cross section of a dynamoelectric machine corresponding to another example embodiment of the present invention.

FIG. 9 shows another cross section of a dynamoelectric machine corresponding to another example embodiment of the present invention.

FIG. 10 shows another cross section of a dynamoelectric machine corresponding to another example embodiment of the present invention.

FIG. 11 shows another cross section of a dynamoelectric machine corresponding to another example embodiment of the present invention.

FIG. 12 shows another cross section of a dynamoelectric machine corresponding to another example embodiment of the present invention.

FIG. 13 shows another cross section of a dynamoelectric machine corresponding to another example embodiment of the present invention.

FIG. 14 shows another cross section of a dynamoelectric machine corresponding to another example embodiment of the present invention.

FIG. 15 shows another cross section of a dynamoelectric machine corresponding to another example embodiment of the present invention.

FIG. 16 shows another cross section of a dynamoelectric machine corresponding to another example embodiment of the present invention.

FIG. 17 shows another cross section of a dynamoelectric machine corresponding to another example embodiment of the present invention.

FIG. 18 shows another cross section of a dynamoelectric machine corresponding to another example embodiment of the present invention.

FIG. 19 shows another cross section of a dynamoelectric machine corresponding to another example embodiment of the present invention.

FIG. 20 shows another cross section of a dynamoelectric machine corresponding to another example embodiment of the present invention.

FIG. 21 shows another cross section of a dynamoelectric machine corresponding to another example embodiment of the present invention.

FIG. 22 shows another cross section of a dynamoelectric machine corresponding to another example embodiment of the present invention.

FIG. 23 shows an exploded cross section of a dynamoelectric machine corresponding to another example embodiment of the present invention.

FIG. 24 shows another cross section of a dynamoelectric machine corresponding to another example embodiment of the present invention.

FIG. 25 shows another cross section of a dynamoelectric machine corresponding to another example embodiment of the present invention.

FIG. 26 shows another cross section of a dynamoelectric machine corresponding to another example embodiment of the present invention.

FIG. 27 shows another cross section of a dynamoelectric machine corresponding to another example embodiment of the present invention.

FIG. 28 shows an exploded cross section of a dynamoelectric machine corresponding to another example embodiment of the present invention.

FIG. 29 shows a perspective and side view of a dynamoelectric machine corresponding to another example embodiment of the present invention.

FIG. 30 shows another cross section of a dynamoelectric machine corresponding to another example embodiment of the present invention.

FIG. 31 shows another cross section of a dynamoelectric machine corresponding to another example embodiment of the present invention.

FIG. 32 shows another cross section of a dynamoelectric machine corresponding to another example embodiment of the present invention.

FIG. 33 shows a perspective view of a dynamoelectric machine corresponding to another example embodiment of the present invention.

FIG. 34 shows a cross section of a dynamoelectric machine corresponding to another example embodiment of the present invention.

FIG. 35 shows another perspective view of a dynamoelectric machine corresponding to another example embodiment of the present invention.

### DETAILED DESCRIPTION OF EXAMPLE EMBODIMENTS

Example embodiments of the present invention will now be described with reference to the Drawings.

Example embodiments of the present invention are usable for electric motor applications as well as generator applications. In the electric motor field, motors function at their peak efficiency at a fixed RPM and load value specific to each design. This is ideal when the motors are part of a system such as running a conveyor belt at a specific speed and with a steady load. Design engineers just choose the right kind and size of motor for the application and it will always run efficiently. But if either the load or the RPM of the motor changes, the motor moves out of its highest efficiency range thus reducing range and power.

For example, propelling a car is one of the most variable operating environments an electric motor can face. The vehicle stops, starts, goes backward, accelerates, decelerates, goes up and down hills, and carries a variable amount of passengers and loads. Because the load demands and RPM are constantly changing, the electric motor is often running outside its ideal efficiency zone.

Similarly, in the electrical generator field, generators are typically structured such that they output a peak power at a predetermined rotational frequency. This rotation frequency is typically chosen based on a desired AC power frequency such as, for example, 60 Hz. When an input rotation speed to the generators exceeds that which is required to output the peak power at the predetermined rotational frequency, then the rotating speed of the generator is reduced through braking or other mechanisms. This braking operation results in a large efficiency loss, as the generator is not able to use all of the energy provided by the input rotation speed.

An electric motor that can adjust itself instantly to its constantly changing operating conditions can add considerable range to the vehicle with increased propulsive and regenerative braking efficiency. Similarly, an electric generator which would be able to constantly and dynamically change its power generation parameters would be able to efficiently generate power over a continuous operation band including different environmental parameters.

A more advanced understanding of generators and motors is that they are not the device, nor the sum of their physical parts. The actual generator/motor is only the interaction of electric and magnetic fields. Thus, the only portion of the device that does the work is invisible and untouchable. All the physical components and systems just house the fields. It is erroneous to think of a motor/generator as being a physical device made of assembled parts. It is not a machine, it is an interface between two energies of magnetism and electricity. The physical parts are just a structure to generate and direct the two energies.

Starting with conceptualizations of perfect field interactions and working backward to understand the parts needed to foster and foment those perfect interactions makes it possible to discover and create entire novel lineages of motors and generators according to example embodiments of the present disclosure.

### First Example Embodiments

First example embodiments of the present disclosure provide novel improvements which are directed towards increasing the magnetic field strength, organization, and effectiveness, and include a family of generally cylindrical embodiments, which are developed into conical embodiments in the next section. Because the completed device involves a series of innovations that build on the ones before, they will be described sequentially starting with the most simple, basic permutation, and then building on previous permutations. The improvements generally fall into at least one of two categories. The first is improving magnetic field function and strength, the second is improving the generator/motors adaptability to function well with a wide range of variable input forces.

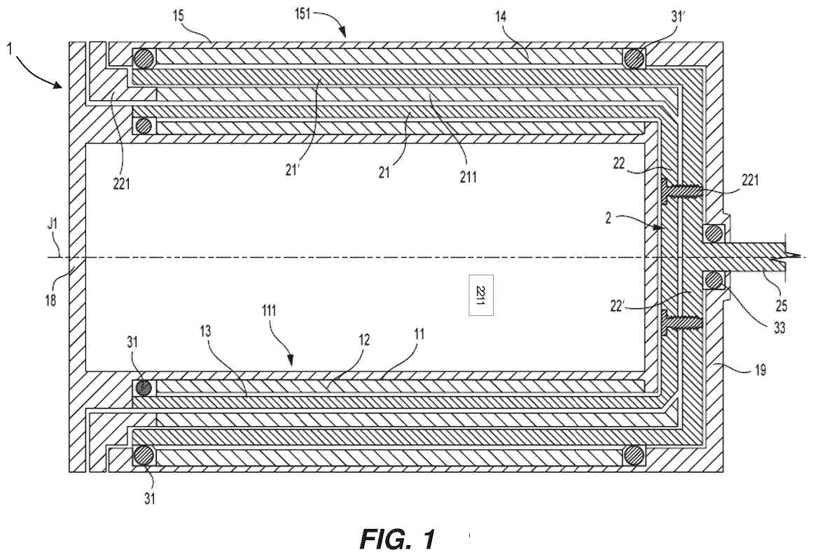

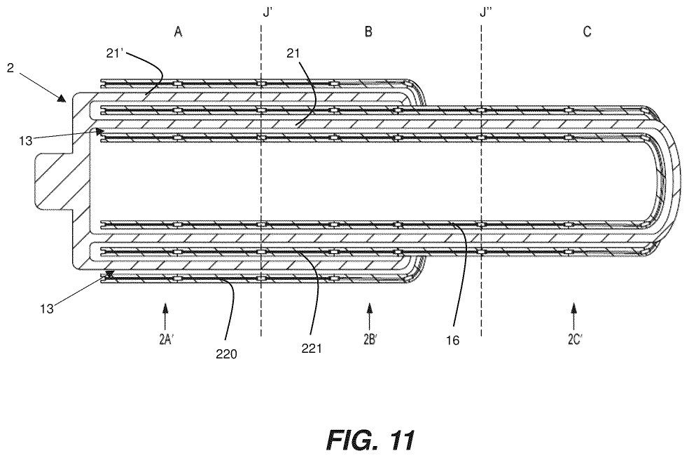

In the family of novel example embodiments described herein, the new stator will preferably include a minimum of 2, different diameter, concentrically nested, stator magnet layers (See FIGS. 1 and 6-8). In some other example embodiments, there will be additional stator layers between the levels of the multi-layer rotors (see, for example FIGS. 1 and 11).

FIG. 1 shows the general components of first example embodiments of a dynamoelectric machine of the present invention. The dynamoelectric machine preferably includes a rotor 2 which is opposed to a stator assembly 1 which includes two opposing stator yokes 11 and 15, upon which are, respectively, inner stator magnet 12 and outer stator magnet 14 magnetized in a radial direction with an airgap 13 therebetween. All of the rotor 2 and the stator magnets 12 and 14 and the yokes 11 and 15 preferably have conical or cylindrical shapes. The rotor 2 may include conductors 21 (preferably linear conductors) which are structured to rotate with respect to the stator yokes 11 and 15. The stator yokes 11 and 15 include magnets (preferably permanent magnets 12, 14 and/or electromagnets 16, 220) which generate magnetic fields in the airgap 13 through which the conductors 21 of the rotor 2 rotate.

As shown in FIG. 1, a stator assembly 1 according to one example embodiment of the present disclosure includes at least an inner yoke 11 with an inner permanent magnet 12 and an outer yoke 15 with an outer permanent magnet 14 which are concentrically positioned and define a hollow cylindrical or frustum air gap 13 (or magnetic flux region) between them in which a rotor assembly rotates. The inner permanent magnet 12 and the outer permanent magnet 14 are generally radially magnetized, usually, with opposite poles facing each other across the space between the concentric layers of the inter magnet air gap 13, i.e., they can be north outside/south inside or they can both be south out, north in. Generally, the air gap 13 contains the powerful inter-magnet radial field(s) throughout the entire length and annular volume. This is in contrast to prior art stators which generally either arc across the diameter of the stator or from the stator ring and back to a different spot on the outer ring that is not directly across.

Stationing the magnets (e.g., the inner permanent magnet 12 and the outer permanent magnet 14) in accordance with example embodiments of the present disclosure increases field strength due to magnet proximity, preventing field bulging and avoiding cross-fielding as described below.

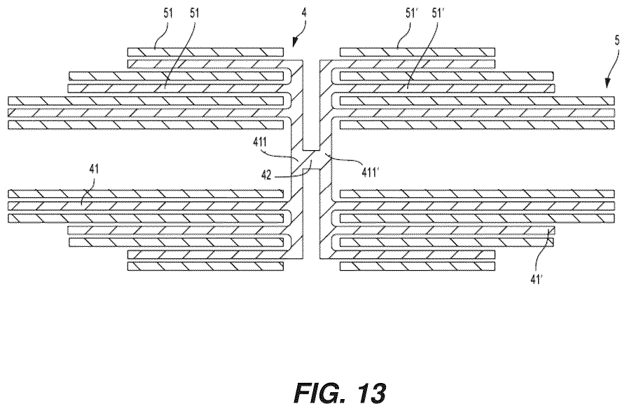

The inter-magnet airgap(s) 13 in most of the example embodiments of the present disclosure is/are structured just wide enough to hold the body of the rotor 2 (discussed elsewhere in this specification) with a minimal gap on either side to prevent rubbing. But, as described below there are some example embodiments wherein the stators (e.g., 11 and 15) and rotor(s) 2 have areas with increased or gradient changes of gap width (see, e.g., FIG. 13).

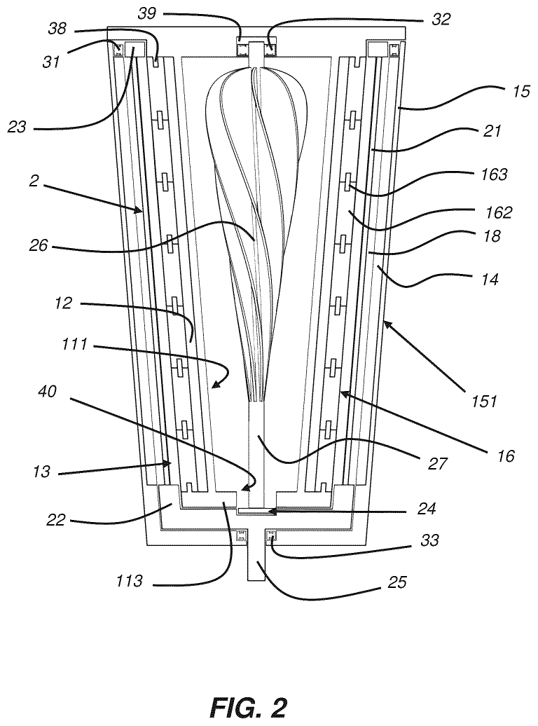

The dynamoelectric machine in FIG. 2 preferably further includes a fan 26 located in a central tube 111 of the inner yoke 11. The fan 26 preferably has a spiral shape, and includes a fan shaft 27 which is fixed to the rotor 2 through a rotor fixing point 24 to rotate together with the rotor 2. The fan 26 generates an airflow to cool the components of the dynamoelectric machine.

The rotor 2 preferably includes a upper rotor ring 23 and rotor support frame 22 which are provided on opposing axial ends of the rotor conductors 21. An upper rotor bearing 31 is preferably provided between the upper rotor ring 23 and the outer stator 4. The rotor support frame 22 preferably includes an integrally provided drive shaft 25 which, in the case of a generator, receives a rotational input to rotate the rotor 2, and which, in the case of a motor, outputs a rotational force to drive an attached member.

As shown in FIG. 2, the inner yoke 11 preferably includes housing upper end 18 and a lower support plate 113 which are provided on opposing axial ends of the inner yoke 11. The inner yoke 11 is structured to support an inner radial surface of the inner permanent magnet 12 (which could be a permanent magnet, an electromagnet, or a hybrid permanent/electro magnet). The housing upper end 18 and the lower support plate 113 both preferably include linking tabs 38 which are structured to support axial portions of the inner electromagnet stator 16. The housing upper end 18 preferably includes a recess 39 which houses an upper shaft bearing 32 which rotatably supports an upper end of the shaft fan shaft 27. The lower support plate 113 preferably includes an opening 40 through which a lower end of the fan shaft 27 extends. The lower end of the fan shaft 27 is preferably affixed to a rotor fixing point 24 defined in the rotor support frame 22. The rotor fixing point 24 may include a recessed structure extending into the rotor support frame 22 and the lower end of the fan shaft 27 may be attached within the rotor fixing point 24 using, for example, fasteners, adhesives, welding, etc.

The outer stator yoke 15 preferably includes a housing lower end 19. The housing lower end 19 preferably includes a recess 192 which houses a lower shaft bearing 33 and an opening 193 which permits the driving shaft 25 to extend out through housing lower end 19. The lower shaft bearing 33 is structured to rotatably support the driving shaft 25. The outer yoke 15 which defines an outer shell 151 of the stator assembly 1. The outer yoke 15 is structured to support a radially outer surface of the outer permanent magnet 14 and to provide a flux path as well as cooling fins.

The inner electromagnet stator 16 preferably includes a plurality of bobbins 162 which are wound with wires of an electromagnet coil 17 and a plurality of linking plates 163 which interconnect adjacent ones of the bobbins 162. In other example embodiments of the present invention, the bobbins 162 may be replaced/exchanged with teeth. Further, the plurality of linking plates 163 may be omitted if coils which are wound on the plurality of bobbins 162 are too large to provide the clearance for the linking plates 163, which may be coils.

In example embodiments of the present disclosure, because the magnetic field is defined by magnets (e.g., permanent magnets 12, 14 and/or electromagnets 16, 220) that are closer to each other, the field is much stronger. With the magnet layout of example embodiments of the present invention, the fields are prevented from bulging the way they do in the conventional structures, making them still stronger, the field is 100% ordered, without cross-fielding or incorrectly orientated sections. A traditionally large, heavy and expensive laminated central rotor core and the laminate stator case are not needed, thus reducing the weight in half. These advantages and the others described in the advantages section, allow the motor and generator to be made smaller, lighter, and more powerful. Better magnetic utilization means less expensive and non-rare earth magnets can be used.

The generally cylindrical configuration requires a novel rotor. Starting with the theoretical simplest example embodiment of the present invention, the rotor can be one, or more than one, generally cylindrical tube(s) of electrically conductive material(s) suspended such that it can rotate within the inter-magnet air gap 13.

This rotor positioning and rotation can be accomplished by various structures including the bearings 31, 31′, 32, and 33 associated with the ends and/or end caps of the stator assembly 1 and the rotor 2. This arrangement creates a significantly higher-efficiency/power rotor. In this most basic permutation, as the rotor 2 turns, the entirety of the inter-magnetic rotor wall (i.e., the rotor conductors 21), throughout its length, circumference, and thickness, transects a radial inter-magnetic field at right angles to the radial field lines. The rotor 2 does this throughout 100% of the rotation duty cycle. There is not another conventional rotor design that achieves that. All other conventional designs have dead zones in the rotor and field relative dead zones in their path of travel, with parts and regions of the rotor that do not contribute to torque or electricity production.

In example embodiments of the present invention, increasing the rotor length increases the voltage produced. Increasing the cross-sectional thickness of the rotor wall, Provided the stator field is adjusted to a constant flux density, increases amperage as long as neither the field nor metal has reached saturation. Increasing the stator and rotor diameters will increase the number of field lines per second being transected for a given RPM, which will lower the cut in speed and increase the power produced, while also increasing amperage in a second way. The larger rotor has a bigger circumference so there is more volume of metal. This increases the amount of metal that is simultaneously transecting the field lines so there is increased amperage.

The rotor thickness and inter-magnet air gap space width for each of these permutations is best optimized by balancing multiple factors including stator magnetic field strength range, included ways of fostering the rotors flux conductivity, material's susceptibility to current induction, magnetic permeability/saturation, amperage vs. voltage, expected RPM range, current and voltage loads, cooling requirements, type and amount of ferrous or magnetically permeable material used in the rotor, and need for longitudinal gradient strength in the magnetic field.

Such a simple, elegant, and relatively monolithic type of rotor has several advantages. It can rotate at a very high speed with minimal effect from the vibrations and centrifugal force that would destroy other structures. Virtually its entire mass can be current producing. There are no gaps such as the space between wires in a coil, allowing full use of the EMF active inter-magnet zone. It can be cast, machined, 3D printed or even extruded as a single piece saving manufacturing time, cost, and complexity. It does not require the expense and weight or complexity of a laminated metal core.

In addition to incorporating any combination of the above described attributes, first example embodiments of the present invention are additionally adapted such that the overall shape may become a tapering, generally conical frustum, including layers of similar concentric, but now generally conical, frustum segments. Each of these permutations is combinable with the other permutations to adapt the technology to specific applications.

As discussed below, shaping the stator assembly 1 and the rotor 2 in a generally conical frustum fashion confers a powerful ability to use a greater range of variable input's own force to make the generator instantly adapt to exactly match the strength of generator needed for maximal energy harvest of that input. This adaptation of gaining and dismissing generator strength to match the input force is seamless, instant and occurs without additional equipment, gears, clutches, brakes, active airfoils, computers, sophisticated controllers, etc. Much of that adaptability and its control are derived from the intrinsic advantages of the conical or stepwise cylindrical shape.

A correctly oriented wire or conductor, moving in the correct direction and speed such that transects enough correctly oriented field lines will experience both (1) an Electro Magnetic Force (EMF) that induces electrons to move down the length of the wire and (2) resistance to the motion proportional to the amount of current created. It is important to understand that a certain number of field lines per second must be transected for the creation of sufficient EMF to initiate the current flow. If the wire is moving too slowly or the field is too weak to supply the requisite field lines per second, current does not flow.

When a frustum is rotated about its central axis (height), all longitudinal points turn at the same RPM. Because points toward the wide end have to go further around their larger circumference in each revolution, they move proportionally faster and farther than points closer to the narrow end. For example, if the wide end had twice the diameter of the narrow end, points at the wide end have to travel twice the distance as those on the narrow end and therefore move twice as fast. In this description, the terms conical, generally conical, and frustum include but are not limited to shapes similar to Gabriel's Horn/Torricelli's Trumpet and convex-sided similar shapes. These terms also cover shapes that function similarly but have the sections arranged with step-wise diameters and/or not by radius gradient change, rather than conical. An example is shown in FIGS. 1 and 8-13. When referring to shapes such as cones, conical, generally conical, frustum, etc., all generally similar thick walled open-ended hollow structures are being described.

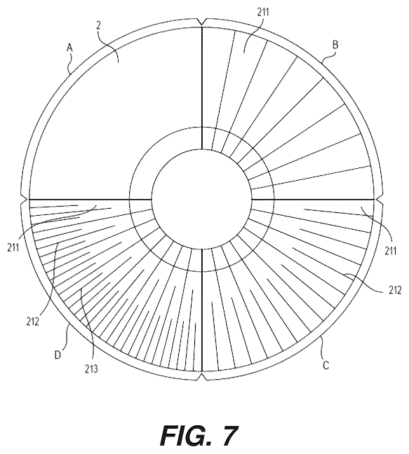

As shown in FIG. 7, the tapered rotor 2 is shown with a narrow end facing outward from the drawing. The tapered rotor has been quartered to show different ways to create laminations. Please note that FIG. 7 is for informational purposes only. Actual devices will preferably have the structure of only one of the quadrants in FIG. 7. In the A quadrant of FIG. 7, the rotor 2 is solid and not laminated. In the B quadrant, the rotor 2 is formed of simple laminated tapering bars 211. In the C quadrant, the individual bars 211 are additionally longitudinally split 212 at a point where wideness can cause problems. In the D quadrant, each bar is split three times with the center split 212 going further down the bar 211 than the lateral splits 213.

The thinnest areas of the bars 211 might heat up if they are too small due to the decreased ampacity of the smaller cross-section of metal. This could partially be addressed by making the narrow end radially thicker to give it a greater cross-sectional area. It could also be addressed by giving that area a more robust cooling mechanism. Because the inner air chamber is narrower on the end that would be more apt to heat up, it experiences a greater venturi wind flow which would give it naturally increased cooling. There are permutations where the cooling air enters from that side so it also experiences the coolest air.

The number of bars 211 into which the rotor 2 is split is limited by the ampacity of the narrowest part and the maximum evolved amps. Interestingly, the amount of amperage created depends on the radial thickness of the bar 211, so as the amount of amperage created by the additional thickness of the bar 211, the ampacity also increases.

The preferred radial thickness of the rotor 2 is derived from the balance of a number of factors. The more metal in the magnetic field (up to the point of saturation), the more power that will be evolved. However, when the amount of metal increases, and the distance between the stator magnets (i.e., the air gap) must also be increased to fit the rotor 2, it drops the field in the ratio to the cube of the increased distance. So a balance needs to be achieved between the most metal possible without weakening the field strength beyond the point of diminishing returns.

From the perspective of the magnets, copper space is essentially the same as airspace (i.e., is a magnetic void). The prior art partially sidesteps this problem with laminated cores that conduct flux. As an alternative, example embodiments of the present invention include a specifically structured architecture of mixtures of one or more of iron, silicon steel, mu metal, permalloy, supermalloy and the like highly magnetically permeable materials in the form of particles, filaments, and the like embedded within the copper of the rotor. In the prior art, this would not be possible because the electrical and magnetic conducting components need to be kept separated to prevent inducing fields that would produce a reverse EMF for reverse eddy currents. Such a problem is much less likely to occur in the structures of the example embodiments of the present invention.

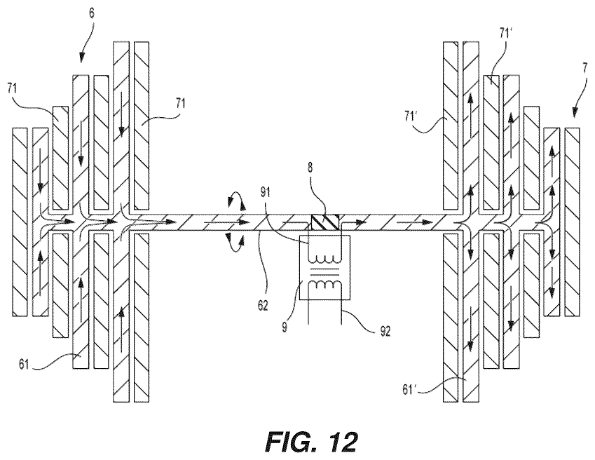

As shown in FIG. 12, there is a permutation of an example embodiment of the present invention which includes a structure and/or circuitry to feed back the current being developed at the negative end of the rotor to its positive end, reminiscent of a power bussing system that can repeat the current's flow through the magnetic field, increasing the voltage each time around. As the voltage passes a certain threshold, it powers electrical collection circuitry including, for example, a step up transformer apparatus, power conditioner, converter circuitry, or inverter circuitry such that the preferred higher voltage and conditioned current can be selectively directed out of the generator.

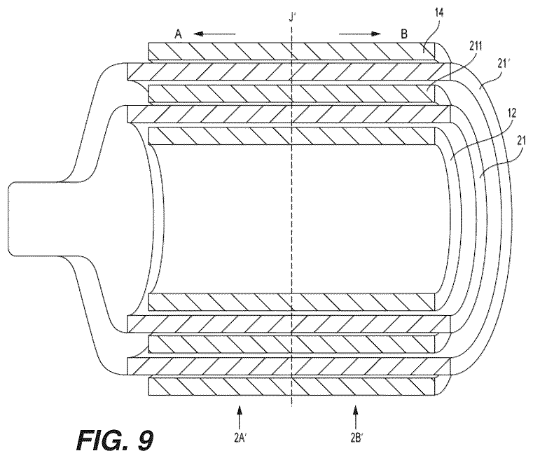

In another additive, roughly cylindrical way of further widening a generator's ability to adapt to a greater range of inputs is to make it a multi-rotor device as in FIGS. 9 and 10-13. Because the outer rotor is moving faster and throughout a larger area, it transects more lines per second and will cut in at a lower RPM than the inner rotor layer. The magnet layers could have different field strengths and or gradient fields to further tune this advantage.

Brushes function as part of current collecting for many types of generators. They have the disadvantage of being a wear item that needs intermittent replacement. They arc and spark and they wear down into an electrically conductive dust that can contaminate the device. While a variety of brushes and commutators could be used in later described example embodiments of the present disclosure, in an example embodiment, the bearings are specially adapted with conductive lubricant to function as current collectors obviating the need for brushes. Part of this novel adaptation is insulating layers in areas needed to prevent electrifying the yoke, etc.

The rotor segments could be collectively bussed together by a current collector at the ends to create a high amperage, low voltage system. The bar segments can be bussed together in a more serial circuit to make a higher voltage/lower amperage output. Different segments can be bussed together for three-phase and AC example embodiments described in later applications. They can be bussed or commutated such that current from one segment is transferred back to a different segment's far end, creating a series circuit to increase the voltage.

In some example embodiments, the individual segments can be serviced, grouped, or excluded by a controller and a series of brushes/commutators. This would be advantageous in AC, three-phase, and direct grid intertie systems.

The stators could be electromagnets with polarity electronically controlled, of variable power, and reversible. The rotor could be longitudinal electromagnets that are polarity controlled, variable electromagnets. In motor applications, the stator could be permanent magnets offset in alternating polarity. The rotor could embody electromagnets that could be activated in a pattern and polarity that cause the rotor to spin. Conversely the longitudinal electromagnets could be in the stator and longitudinal alternating polarity permanent magnets could be in the rotor. The stator magnets could be flash electrified in patterns and polarity to force the rotors' torque. The pattern and speed of the electromagnets can be varied for various torque, loads, and RPM operating conditions to create differing torque or speed or to maximize efficiency. These permutations will be further discussed below.

### Second Example Embodiments

FIGS. 9-11 and 13 provide renderings and diagrams of the structures of some additional example embodiments of the present invention. For the sake of brevity, only elements of the additional example embodiments which are different from the above described example embodiments and permutations will be described in detail.

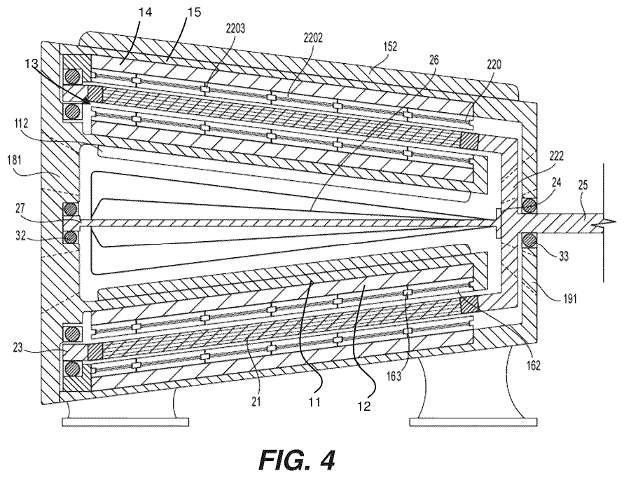

FIG. 4 shows an example embodiment in which the stator assembly 1 preferably includes an inner stator yoke 11 and an outer stator yoke 15 which respectively include an inner electromagnet stator 16 wound with an electromagnetic coil 17 and an outer electromagnet stator 220 wound with an electromagnetic coil 17. The inner stator yoke 11 and an outer stator yoke 15 further respectively include an inner permanent magnet 12 and an outer permanent magnet 14. By using both permanent magnets and electromagnets, the stator assembly 1 is able to have a strong magnetic field produced by the permanent magnets which can also be adjusted by changing the current flowing through the electromagnetic coils 17 of the inner electromagnet stator 16 and the outer electromagnet stator 220.

The example embodiment of FIG. 4 also shows that surfaces of the inner stator yoke 11 and the outer stator yoke 15 may include cooling fins. Further, the housing upper end preferably includes upper ventilation openings 181, the housing lower end 19 preferably includes lower ventilation openings 191, and the rotor support frame 22 preferably includes rotor ventilation holes 222. The upper ventilation openings 181, the lower ventilation openings 191, and the rotor ventilation holes 222 permit an airflow to be directed through the central tube 111 by the fan 26 to further aid in cooling.

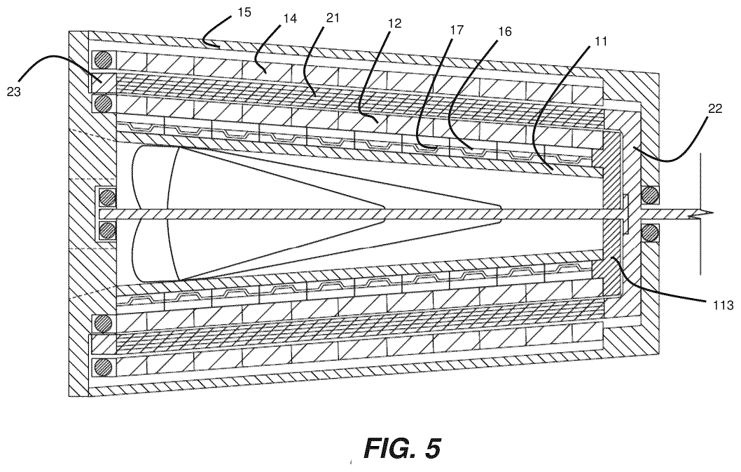

FIG. 5 shows an example embodiment in which the stator assembly 1 preferably includes an inner stator yoke 11 which includes an inner electromagnet stator 16 wound with an electromagnetic coil 17 and an inner permanent magnet 12 which is defined by a plurality of laterally stacked permanent magnet ring frustum elements. The outer stator yoke 15 preferably includes an outer permanent magnet 14 which is defined by a plurality of stacked permanent magnet elements.

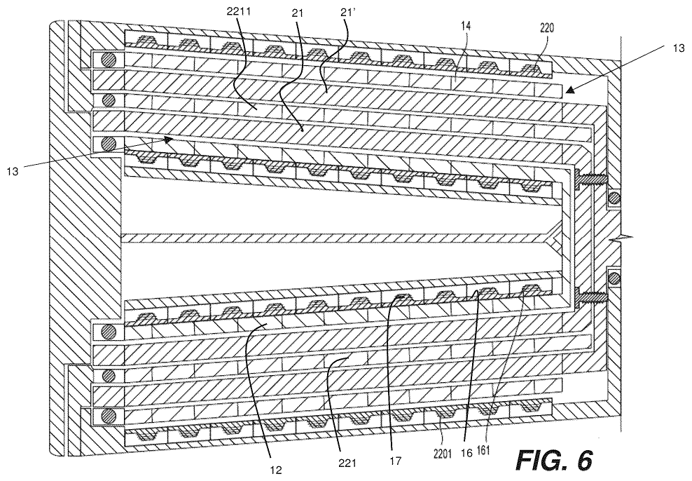

FIG. 6 shows an example embodiment in which the stator assembly 1 preferably includes an inner electromagnet stator 16 wound with an electromagnetic coil 17 (the inner electromagnet stator 16 could be defined by a permanent magnet with projections 161), an inner permanent magnet 12 which is defined by a plurality of stacked permanent magnet elements, a middle stator 221 which includes permanent magnets 2211, an outer permanent magnet 14 which is defined by a plurality of stacked permanent magnet elements, and an outer electromagnet stator 220 wound with an electromagnetic coil 17.

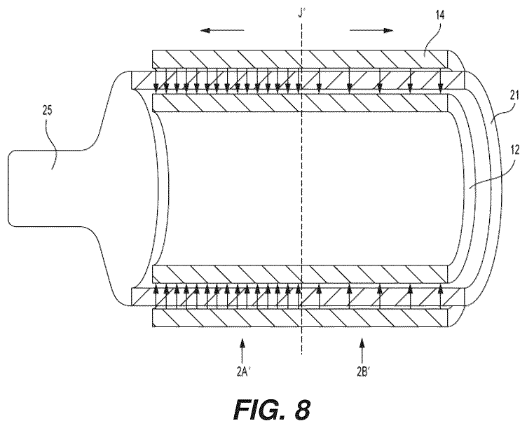

FIG. 8 shows an example embodiment in which a rotor conductor array 21 is rotated between an outer permanent magnet 14 and an inner permanent magnet 12 which include different gradient magnetic field strength areas 2A′ and 2B′ which are separated at a dividing line J′. With this arrangement, the left side of the rotor conductor array 21 cuts through a greater density of flux than the right side, causing it to cut in and ramp up power production at a lower rpm than the right side. This makes its output and the force needed to accelerate it more responsive to changing rpm. There can be multiple gradient magnetic field strength areas, not just two. Further, the field strength could also change in an analog gradient fashion longitudinally.

FIG. 9 shows an example embodiment in which a rotor 2 including an inner conductor array 21 and an outer conductor array 21′ is rotated between air gaps 13 defined between an outer permanent magnet 14, a middle permanent magnet 221, and an inner permanent magnet 12 which each include different gradient magnetic field strength areas 2A′ and 2B′ which are separated at a dividing line J′. With this poly rotor iteration, while each rotor conductor array 21 and 21′ has the same rpm, each travels a different distance and a different speed to make each revolution. Therefore, the outer rotor array 21′ material will go farther and faster around each revolution than the inner rotor array 21 material.

If both inner and outer stator air gap fields 13 have the same flux density, the outer rotor 21′ will kick in sooner and ramp up power production at a lower RPM increasing the way power output varies with changes in rpm, e.g., at a certain speed the outer rotor 21′ has kicked in but the inner rotor 21 is not yet producing meaningful power. At a higher rpm, now the air gap fields both are producing meaningful power thus adding additional adaptability, each of these separate rotor's fields can be of different intensities, plus each can vary longitudinally as long as they are homogenous circumferentially.

In FIG. 9, the longitudinal difference is divided into the gradient magnetic field strength areas 2A′ and 2B′. Now there are 4 distinct regions including outer rotor 2A′ and 2B′ as well as inner rotor 2A′ and 2B′. Each distinct region kicks in and starts ramping up power production at a specific rpm. This further widens the range of responsive change in power production as the rate with which the rotors are spun varies.

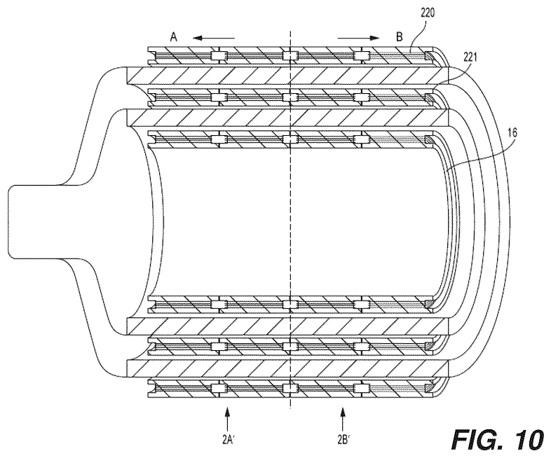

FIG. 10 shows an example embodiment in which a rotor 2 including a conductor array 21 and an outer conductor array 21′ is rotated between two air gaps 13 defined between an outer electromagnet stator 220, a middle electromagnet stator 221, and an inner electromagnet stator 16 which are each able to produce different gradient magnetic field strength areas 2A′ and 2B′ which are separated at a dividing line J′. The two airgaps 13 define four flux regions, two for each of the opposed stator arrangements (e.g., in the 4 distinct regions: outer rotor 2A′ and 2B′ as well as inner rotor 2A′ and 2B′). Further, 2A′ and 2B′ can be further split into different strength field sections by differentially powering the electromagnet of the stator. The electromagnets of the stator could also be hybrid combined permanent and electromagnet magnets.

Now, the stator field intensity for each segment can be individually increased or decreased through the electromagnets. This confers multiple changes, for both when this machine is used as a generator and when used as a motor. Focusing on the generators used for wind power, and that when the wind speed rises there is more power to harvest, conventional generators have to waste the lucrative power to prevent overspin of the generator or blade tips. In this generator, before either overspin phenomena can happen, and as the power output ramps up (in addition to the increased resistance to acceleration conferred by the different radii areas of rotor, different areas of baseline magnetic field strengths, different rotor thicknesses and air gaps, etc.), the final protection against over spin is that some of the large extra power output can be diverted to the electromagnet coils, increasing the stator field intensity to its maximum in all segments. This increases the flux that is being transected by the rotors, increasing both the power output but also increasing the amount of force needed to spin and accelerate the generator/turbine. This prevents or forestalls overspin.

In gusty winds, the control algorithm preferentially electrifies certain electromagnets more than others to make a greater range of field intensities so the machine becomes more responsive to sudden changes in wind speed. In low wind conditions, the electrification to the electromagnets is minimized to make it the equivalent of a small, easy to spin, low output generator.

FIG. 11 shows an example embodiment in which a rotor 2 including an inner conductor array 21 and an outer conductor array 21′ is rotated between air gaps 13 defined between an outer hybrid electro/permanent stator 220, a middle hybrid electro/permanent stator 221, and an inner hybrid electro/permanent stator 16 which are each able to produce different gradient magnetic field strength areas 2A′-2C′ which are separated at a dividing line J′ and J″.

The above structures and arrangements increase the voltage from the smaller diameter rotor such that it can be more equal to that produced by the larger diameter rotor by varying the flux density, but also by virtue of the longer inner assembly. Having the rotors concentrically positioned also saves on magnet cost and weight. It also multiplies the device power density by making it more compact. It also gives the device a conical shape that is of small aerodynamic advantage.

In FIG. 11 there are three zones of differing baseline magnetic strength (A,B,C) surrounding 2 different diameter/different length rotor conductor arrays (inner 21 and outer 21′). In this configuration there are five zones with different cut in/ramp up characteristics (A/inner rotor, A/outer rotor, B/inner rotor, B/outer rotor, C/inner rotor). Each of these 5 zones contribute to the adaptability because each has a different output/rpm curve based on their individual rotor diameter and magnetic field strength.

Next, a control system which selectively energizes the windings of the electromagnetic components of stators 16, 221, and 220 will be described. With the ability to power each circumferential band of the electromagnetic components of stators 16, 221, and 220, the number of adaptability zones increases, i.e., Section A, as drawn, has 2 electromagnet circumferential bands. If only one is energized, or if they are energized unequally, section A becomes two different sections (A and A prime). So there a total of 10 different zones, for example. Each of these zones have a unique radius to field strength ratio, so taken together, they impart a cone-like variability termed functional conicity.

Each circumferential section can be magnetized not just to one different fixed level of field strength, but to anywhere within a range of multiple magnetic field strengths, so it is not limited to 10 single fixed options for the adaptability/generative/braking characteristics.

In addition, with algorithmic varying of specific circumferential field strengths, a generator corresponding to FIG. 11 can adapt to conditions in a different way. For example, on a high speed wind day, the electromagnets can all be energized uniformly to their maximum to harvest the most power while providing the greatest protection against over spin. Also, on a gusty day, the magnets can be energized with some toward their maximal range and others toward the minimal and the rest in a gradient stratification so as to create a wide spectrum range of different operating parameters so the generator has had its adaptability maximized and it is ready for the highly variable gusty input. On a light wind day, in a case that the stator includes both permanent magnets and electromagnets, the electromagnetic input can be shut off such that the magnetic field in the airgaps 13 of the generator becomes its weakest and easy to spin rating and continues to harvest that range also. Under more constant mid wind speed conditions, the various segments will be adapted to have flux field strengths that improve or optimize output for that input. That is, each segment will be controlled to have the flux density to diameter ratio optimized for maximal output and appropriate braking. For example the inner rotor, traveling less than the outer rotor per rotation will have the field made stronger than that of the outer rotor. Another way of saying this is the two will be made to have the same rotor circumference to flux transection ratio so they will contribute in a balanced fashion.

Note that this electromagnetic control is also applicable to motors, especially EV motors that encounter a tremendously variable set of operating conditions as the car accelerates and decelerates, goes up and down hills, and carries a varying load of occupants and cargo.

Recall that, prior to these novel structures according to example embodiments of the present invention, every type of motor has a small range of load/rpm at which it can operate at >90% efficiency (sweet spot). Outside of that individual type of motor's sweet spot, efficiency can drop to as low as 55%, for example. For constant load and rpm operating applications such as running a conveyor belt, a design engineer maximizes efficiency by simply choosing the type of motor that has a sweet spot that is the same as the operating demands for that machine or system.

With cars, however, the rpm and load are always changing radically. By having a motor that (1) starts with zones that have different sweet spots, but then (2) can change the zone's magnetization, the overall motor's sweet spot can be changed, in real time, to match the instantaneous operation condition of the EV motor, even as they change. The end result is a motor that operates in its sweet spot for a greater range of its operation, so less batteries are needed for greater range.

In one example AC embodiment, all the electromagnets can be AC powered electromagnets. The same generator can power the US's 60 Hz grid as well as the European 50 Hz grid, the Japanese 60 Hz and 50 Hz grids, and all remaining other standard 50 Hz and 60 Hz grids.

FIG. 12 shows an example embodiment in which a lateral double rotor assembly 6 interacts with a lateral double stator assembly 7. The double rotor assembly 6 includes upper rotor disks 61 which are mutually connected to one side of a common connecting shaft 62, and lower rotor disks 61′ which are mutually connected to another side of the common connecting shaft 62. The double stator assembly 7 includes upper stator magnets 71 and lower stator magnets 71′ which are opposed to the upper rotor disks 61 and the lower rotor disks 61′. Note that these disks could be replaced with drums, similar as to what is shown in FIG. 13.

An insulating shaft insert (preferably made of non-electrically conductive resin or non-electrically conductive metal) is preferably provided between the one side of the common connecting shaft 62 and the another side of the common connecting shaft 62 and a transformer or similar component 9 is provided, for example, with input leads 91 connected to the opposing ends of the lateral double rotor assembly 6 is able to provide an output current through output leads 92. The input leads 91 are preferably connected to the opposing ends of the common connecting shaft 62 through brushes or some other rotational connector. While not shown in this figure, the periphery of the left disks is preferably electrically coupled to the periphery of the right disks. The directly generated low voltage/high amperage electrical energy goes in a circle path with the load being the transformer or similar component 9.

It is important to note that the polarity of the magnetic fields are reversed from the left side to the right side in FIG. 12. In this side view, there are six spinning rotor disks (61 and 61′) affixed to, and electrically coupled with the same single axle/spindle rod 62. But for the novel manner of dealing with brush losses to be discussed later, the entirety of the six disks 61 and 61′ and the axle rod could be cast as a single piece from a suitably conductive material and the transformer or similar component 9 would be moved to the connecting wire on the disk periphery. It is also the only moving piece. In this iteration the disks 61 and 61′ have been made with different diameters to confer extra adaptability. All but the end disk magnets 71 and 71′ include a hole in the center to allow the axel rod to pass through. They all are arranged so opposite poles oppose each other across an inter magnet space, which is occupied by the spinning rotor disks 61 and 61′. Note that the group of magnets 71 on the left side are preferably positioned so that south magnetic pole is to the left and north magnetic pole is to the right, while the right sided group of magnets 71′ is positioned so north magnetic pole is to the left and south magnetic pole is to the right. This way, when the axle 62 and rotor 6 are spun, on the left group, electrons are induced to flow from the periphery of the disk to the center and out into the rod. On the right hand side, while the disks rotate in the same direction as those on the left, the magnetic field polarity is reversed so the electrons are induced to flow from the central rod to the periphery of the disks. The magnets can be electro mags or hybrid or permanent magnets in dc versions, and electromagnets in AC versions. While each side's group of disks can be thought of being arranged in parallel so their individual amperage adds together, the two groups are connected in series so the voltages add.

Current collecting brushes (not shown) preferably touch the outer circumferential edges of the disks 61 and 61′. There are several advantages to this layout. The first is reduced brush loss. Sliding brushes collect current but at a penalty of voltage loss.

The more important concept here comes from examining the non-conductive insulating shaft insert 8 and the transformer 9. When the system is an AC generator, the current in the rod 62 now has to pass through a primary winding 91 of the transformer 9 (preferably a step up transformer). For simplicity and lack of vibration, understand the transformer 9 to be a cylindrical transformer built uniformly, circumferentially around the rod axle 62 which rotates together with the rod 62. The high voltage power is taken from the secondary transformer coil 92 via, for example, slip rings or the like.

With this transformer system, the low voltage direct rotor ‘output’ never even has to leave the generator. It only has to travel a short circular distance inside the generator. Its path is practically a short circuit so percentage voltage losses are minimal. The output from the transformer secondary winding 92 is what leaves the generator casing and has high voltage that can be efficiently transmitted.

It is possible to construct a similar system for a generator that uses permanent magnets. The internal circuit can be low voltage DC and the power can go through an internal inverter/converter. Alternatively, one set of the rotor disks/drums 61 and 61′ can have intermittent nonconductive areas built into their outer rims that intermittently interrupt the flow of the dc current. During the off times, the surplus charge is stored in the disks 61 and 61′ and delivered during the on times, as is known to occur with homopolar designs. The dc current flashing on and off can activate a suitably built step up transformer or similarly functioning inverter.

FIG. 12 shows an example embodiment in which a longitudinal double rotor assembly 4 interacts with a longitudinal double stator assembly 5. The double rotor assembly 4 includes upper rotor cups 41 which are mutually connected to an upper base 411, and lower rotor cups 41′ which are mutually connected to an lower base 411′. The lower base 411′ is connected to the upper base 411 through a common connecting shaft 8. The longitudinal double stator assembly 5 includes upper stator magnets 51 and lower stator magnets 51′ which are opposed to the upper rotor cups 41 and the lower rotor cups 41′.

Again, similarly to FIG. 12 but not shown, there could be an internal step up transformer with the primary circuit of low voltage, high amperage primary output traveling only the very short, circular path from the rotor drums 41 and 41′ through the primary transformer winding and back to the rotor drums 41 and 41′. The power induced in the secondary transformer coil leaves the generator. In example embodiments for DC, again, an inverter can substitute for the transformer.

### Third Example Embodiments

With Incumbent toothed generators, so much of the generator volume, weight, and cost is the internal balance of power plant material. The percentage of generator volume that actually makes electricity is very small compared to homopolars. The homopolar generator can be used to create an impedance neutral on an electrical network that does not have one, and to ground this network through this impedance. They can store energy within them as rotational inertia and provide sudden bursts of tremendous amperage. Still, with all these advantages and more, the early forms of homopolar generators made power that had too low a voltage to be of much use and the technology was largely abandoned before the problem was solved.

Generally, when opposing a rotating disk, rotating magnets produce the same amount of power as stationary magnets. The output power is dependent on the disk motion and entirely independent of the magnet's motion. Another paradox is that fields move when a magnet is translated laterally in any direction, the field rotates when a magnet is spun perpendicularly to the north/south axis, but the field acts as though stationary when the magnets are rotated about their north south axis. A simple example of this is a small metal bar on one side of a paper and a disk magnet on the other side of the paper. Moving the magnet in any fashion other than rotating it about its north/south axis affects the metal bar to follow the motion of the magnet. Rotating about that axis does not affect the bar.

More than ever before, the world is demanding electrical machines that can better handle variable conditions. Wind power and electric vehicles are huge and burgeoning markets that have essentially the most variable operating conditions of all electrical machines. Incumbent machine efficiency is largely throttled to one specific operating condition because they are only maximally efficient at a single rpm and load range, and electrical machines in these markets spend nearly all of their life operating well outside of that efficiency ‘sweet spot’ range. Cars move at different speeds, they accelerate and decelerate, go up and down hills, and carry variable loads. Cars drive with and against the wind. As such, for the vast majority of their operation, they are far from their efficiency “sweet spot.” This reduces range by an estimated minimum of 30%. Wind generators function at their peak efficiency when the wind blows at a single speed that turns them at a single model-specific rpm. When the wind is faster or slower, as it almost always is, efficiency drops precipitously. As such, wind power generators can miss half of the harvestable energy. Motors and generators require hundreds to thousands of layers of laminated silicon steel to operate. This is expensive and heavy. They have internal bearings and or brushes that increase maintenance and decrease lifespan. The rotor spins a fraction of a millimeter from the stators, if conditions cause a rotor and stator to rub, the machine is often destroyed.

Homopolar drum generators according to example embodiments of the present invention solve some of these problems, and, with their hollow tubular structure, they can be built to be more adaptable than conventional machines. While conventional homopolar machines have a problem of producing a disadvantageous type of output, with example embodiments of the present disclosure are able to provide a solution.

Current generators have a usually stationary case called a yoke. Usually, adhered to this yoke are one or more of a variety of possible types of stator magnets. Associated with the magnets are hundreds to thousands of coated, stacked (usually silicone steel) laminations that serve both as a path for the flux and to limit eddy currents. There is considerable weight, size and cost in this assembled stator apparatus and it has to be relatively thick. Rotating within the stator apparatus is the rotor, which is also thick and filled with expensive and heavy laminations.

Rotors are usually defined a heavy, complex solid metal cylinder assembled from hundreds to thousands of parts. These devices are incapable of adapting to maintain efficiency in a variable environment, heavy, prone to breakdown, costly, and have relatively low power density compared to a generator built taking advantage of the physical properties of Homopolar drum generators.

The inventor of the present disclosure discovered that, even in a drum motor where the stators rotate, for practical purposes, the electrical field of magnets of the stator acts as if it does not rotate, as discussed above. Therefore rotor and stator layers can be adhered together and spun as one integral armature structure where the stator field acts as though it is stationary. The rotor layer of example embodiments of the present invention still cuts through the field in the same manner as it would in a traditional, non-rotating stator. This allows the rotor layer to be made much thinner, because structural integrity is provided by all of the adhered stator and rotor layers being integrally fixed together, and does not need to be provided for multiple separated layers individually. The stator layers can also be made thinner, not just because structural integrity is shared, but also simultaneously because the rotor layer of example embodiments of the present disclosure is now thinner, moving the magnets closer together so their field is logarithmically stronger but also because less field intensity is required to service the thinner rotor metal. The large airspaces are also done away with by allowing for more thinness of the rotor/stator armature (it is noted that the rotor and stator elements are no longer entirely accurate terms as they both spin together. But these terms will still be used for ease of understanding).

As the stator and rotor layers of example embodiments of the present disclosure are able to be made radically thinner, multiple layers of additional stators and rotors can be concentrically added, all adhered integrally together to define one multi-layered structure. Conceptually and operationally, the layers could be as thin as deposited films or foils, allowing for a tremendous number of electroactive layers. The stator layers would generally have to be thicker than the rotor layers to conduct enough flux, but with advanced, high permeability, high saturation material, this demand is somewhat obviated.

Further, because the drum homopolar shape is preferably a hollow cylinder, there is central room available for yet more electroactive layers to provide additional power in generators, and additional torque in motors. So while the layers are thinner, there may be a great many layers in the same volume. Please see family application Ser. No. 18/232,959, filed on Aug. 11, 2023, which claims domestic priority to 63/373,582, filed Aug. 26, 2022; 63/467,843, filed May 19, 2023; and 63/467,850, filed May 19, 2023 which applications are all hereby incorporated by reference herein for examples of how the layers can be shaped to confer adaptability.

In the case where the adjacent stator layers each provide the opposite polarity, the emf developed in each rotor layer is in the opposite direction of its adjacent rotor layer. Electrically connecting every pair of adjacent rotor layers on the opposite end as the next adjacent rotor layer pair puts them in series, thereby increasing the voltage. Increasing the native voltage in the generator's rotor acts to solves a flaw that caused homopolars to be left behind despite their many inherent advantages.

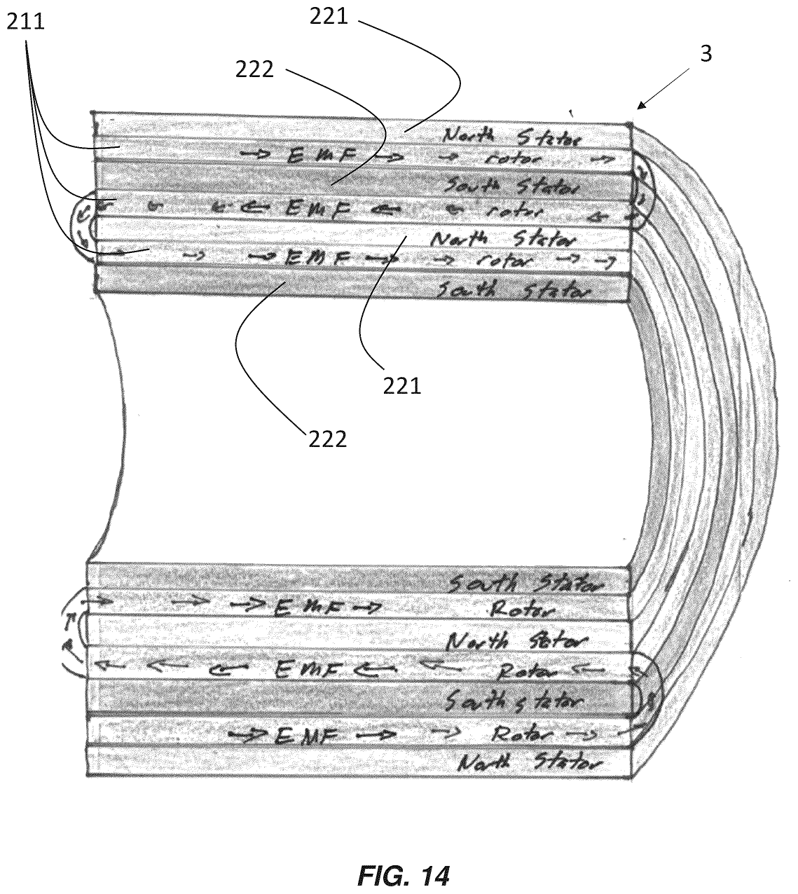

FIG. 14 shows an example embodiment of a homopolar drum device which includes an electromagnetic armature 3 including series connected rotor layers 211 which are structured to increase voltage. In FIG. 14, the rotor layers 211 are sandwiched between alternating north magnetic stator layers 221 and south magnetic stator layers 222. The alternating north magnetic stator layers 221 and south magnetic stator layers 222 correspond to magnetic field generating portions which may be defined by permanent magnets, electro-magnets, ferrous material, etc. The rotor layers 211 correspond to conductive current paths which are preferably defined by copper or other conductive but non-ferromagnetic materials.

The rotor layers 211 are preferably connected so that all the positive ends of each of the rotor layers 211 are electrically continuous with negative ends of adjacent rotor layers 211 such that current or emf may flow in a continuous direction radially inward or radially outward with respect to all of the rotor layers 211. For example, the current or emf should flow radially inward in a serpentine manner as is shown in FIG. 14.

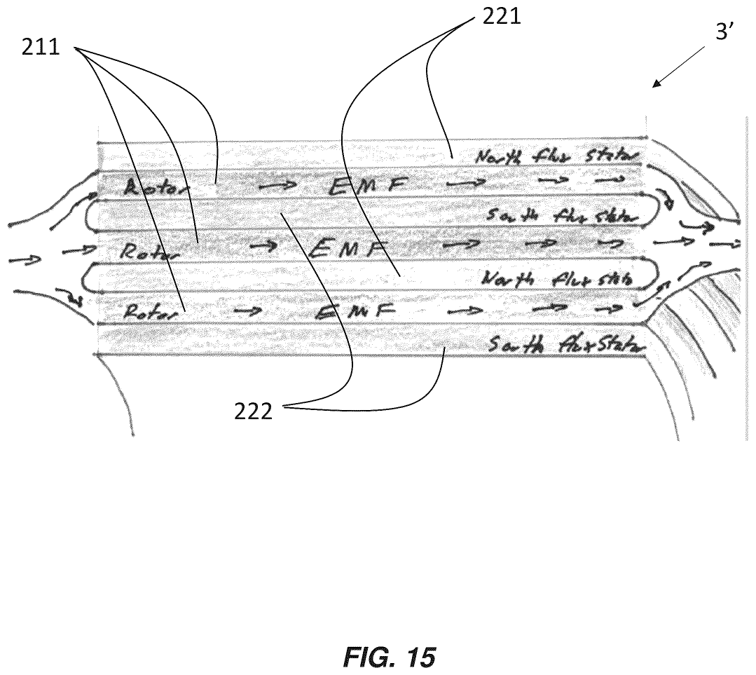

FIG. 15 shows another example embodiment of an electromagnetic armature 3′ according to the present disclosure in which the rotor layers 211 are all electrically connected in parallel with one another to increase amperage. Specifically, positive ends of the rotor layers 211 are all electrically connected on a first axial end whereas negative ends of the rotor layers 211 are all electrically connected on a second axial end. Further, the rotor layers 211 which are electrically connected in parallel are sandwiched between alternating north magnetic stator layers 221 and south magnetic stator layers 222.

The rotor layers 211 could be alternatively provided in arrangements where portions of the rotor layers 211 are electrically connected in series while other portions of the rotor layers 211 are electrically connected in parallel. In the above, the adjacent stator layers 221 and 222 provide alternating opposite polarity flux, but there can be arrangements in which stator layers 221 and 222 may have many different flux patterns.

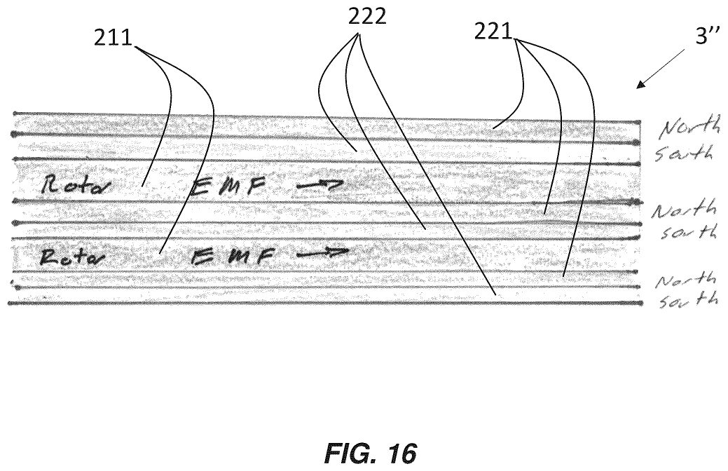

FIG. 16 shows another example embodiment of an electromagnetic armature 3″ in which the rotor layers 211 are located between contiguous pairs of the stator layers 221 and 222. The rotor layers 211 of FIG. 16 are preferably connected in parallel, but could also be connected in series if so desired.

In AC power embodiments the stators may be magnetized with an alternating field or the alternating current can be obtained via a simple DC/AC converter. Although much of the above is coached in terms of generators, motors and generators are the same device, with little to no modification. All the advantages and attributes for generators are applicable to motors as well.

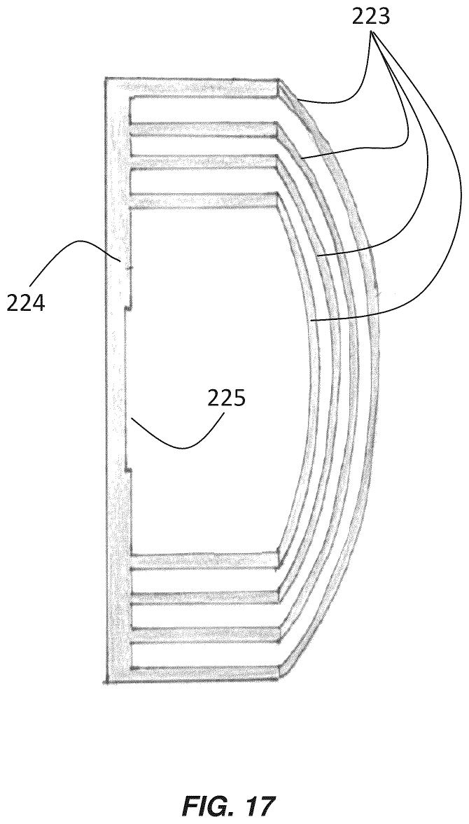

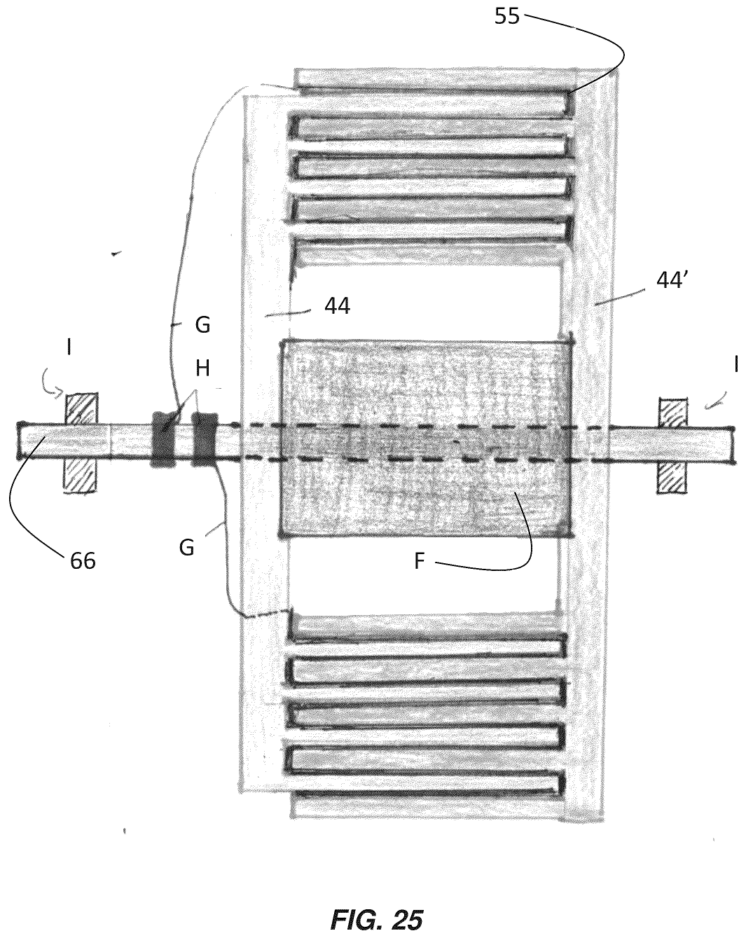

FIGS. 17-28 are a series of stylistic representative diagrams that convey the fundamentals of example embodiments of the present disclosure. They are not proportional and there are many other structures by which the same or similar functionality can be obtained. They are meant as representative of the concept, not as a full disclosure of all possible permutations that should count as generally disclosed here if they are reasonably extrapolatable.

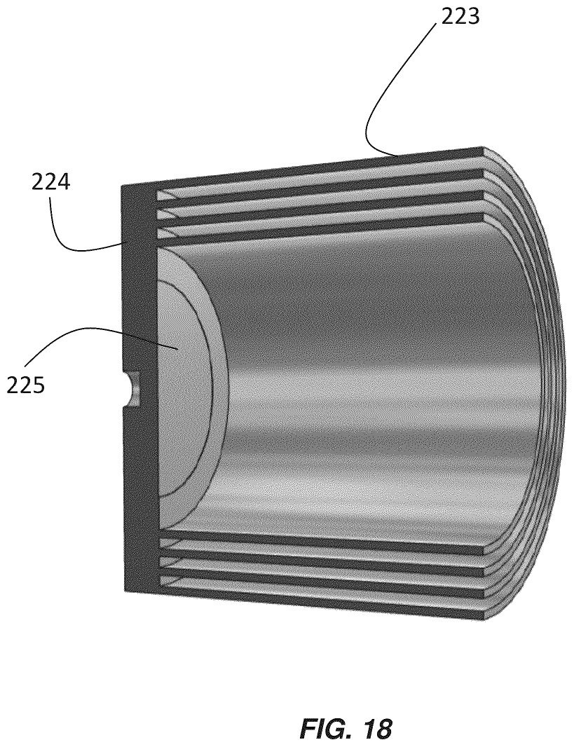

FIGS. 17 and 18 depict representative concepts of a first flux manifold permutation according to an example embodiment of the present invention. FIGS. 17 and 18 are cut away sections, side views of one possible form of a stator apparatus of an electromagnetic armature according to the present disclosure.

As above, the term stator is no longer a perfect fit since the stator of the present example embodiments is a magnetic field portion of a rotating electromagnetic armature, but is being used for ease of explanation. The term “flux manifold” is maybe a more appropriate description of its function. Conceptually the shape being described here is preferably, in this case, four thick, smooth walled hollow cylinders 223 provided monolithically and concentrically protruding from a disk-shaped side wall 224. The sidewall 224 in this case preferably includes a magnet recess 225 on its medial surface.

It can be composed of a material with a suitably high magnetic permeability, flux saturation, susceptibility and coercion. In some example embodiments it can be magnetically annealed and/or formed with permanent magnetic materials to grant intrinsic magnetization. For the sake of simplicity it can be considered here to be made of annealed silicon steel.

In this configuration a permanent, electro- or hybrid electro/permanent magnet is associated with the apparatus in such a way as to energize it with one pole of either north or south flux. In AC embodiments the flux supplied alternates between North and South polarity. The permanent, electro- or hybrid electro/permanent magnet may be associated with the medial side, elsewhere, or may be in or of the flus manifold's base material. In the diagram shown in FIGS. 16 and 17, flux travels from magnet recess 225, out the sidewall 224 into and ultimately out the walls of the concentric stator layers 223.

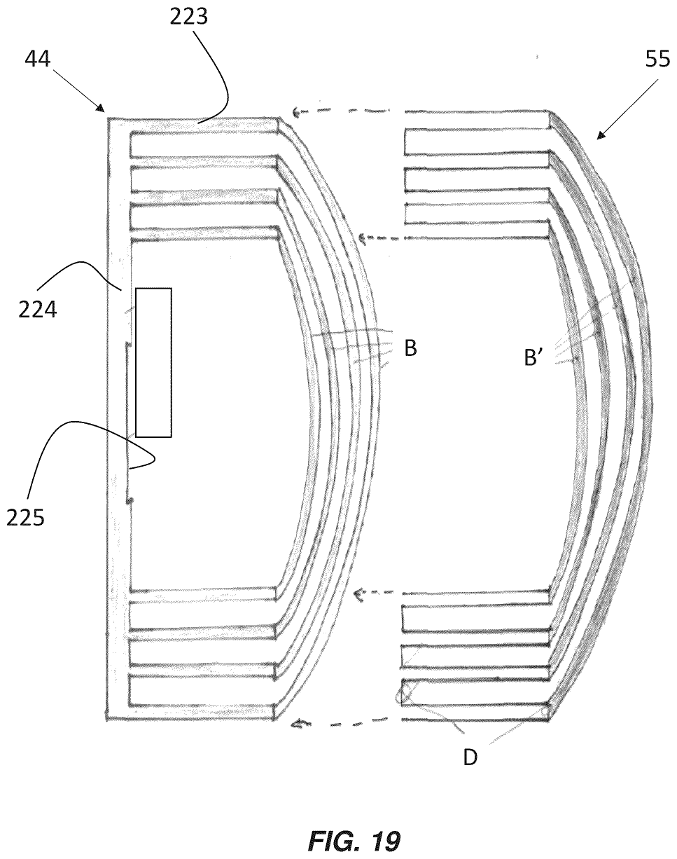

FIG. 19 shows components of an electromagnetic armature including a first flux manifold 44 (e.g., stator) with a series connected rotor material layer 55 (e.g., conductive stator) provided adjacent to the first flux manifold 44. The series connected rotor material layer 55 is preferably defined by a plated copper structure which is fitted over the stator layers of the first flux manifold 44 completely covering the stator cylinders (B) in a continuous layer (B′). The rotor layer can preferably be, for example, a coating, a formed metal piece, sheet metal, a foil, copper wires or plates, or the like.

Note that in the embodiment shown each layer pair is connected at the opposite end of the adjacent layer (D). However, this is not the only configuration for connecting the layers. Further, a thin electrically insulating layer is preferably provided between the flux manifold 44 and the rotor layer 55. Note that this insulating layer is not required in embodiments where the flux manifold is made of a non-conductive material or in which prevention of current flow from the rotor layer 55 to the flux manifold 44 is not wanted. For simplicity we can think of the rotor layer 55 material as being copper, although ferrous/ferric materials can be suitable as can combinations of materials based on the ones in the related applications which have been incorporated herein by reference.

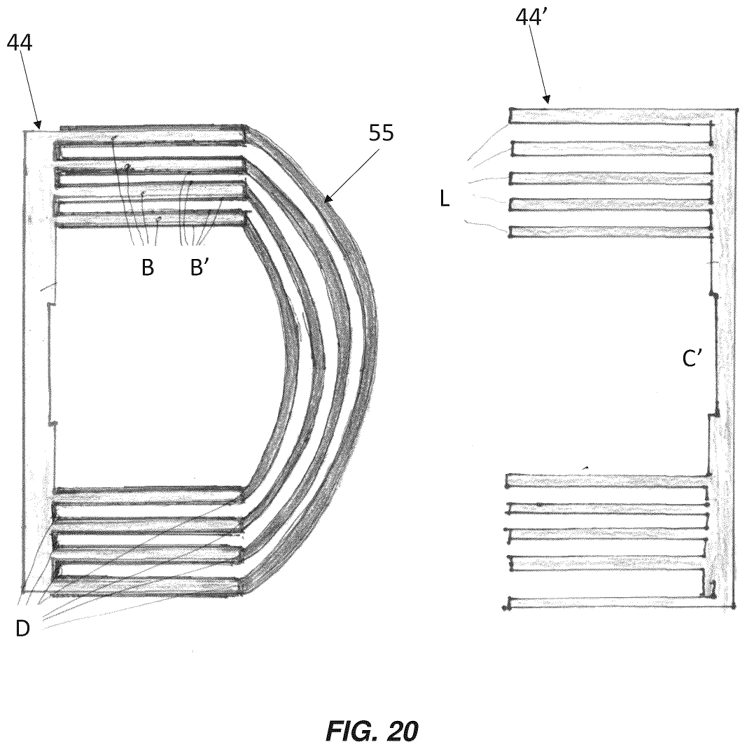

FIG. 20 shows an electromagnetic armature in which a first flux manifold 44 now has the rotor layer 55 applied over a not shown insulating layer, and a complimentary second flux manifold 44′ is located to be aligned with the first flux manifold 44. Note that the second flux manifold 44′ preferably includes one more stator layer (L) than in the first flux manifold 44, that its stator layers (L) are sized to interdigitate with the stator/rotor layers (B,B′) of first flux manifold 44, and that it also has a medial magnet recess (C′). The second Flux manifold 44′ also may have the electrically insulating layer preventing current flow from the rotor layer (B′) in embodiments wherein such is needed. The second flux manifold 44′ may preferably be made of similar material to the first flux manifold.

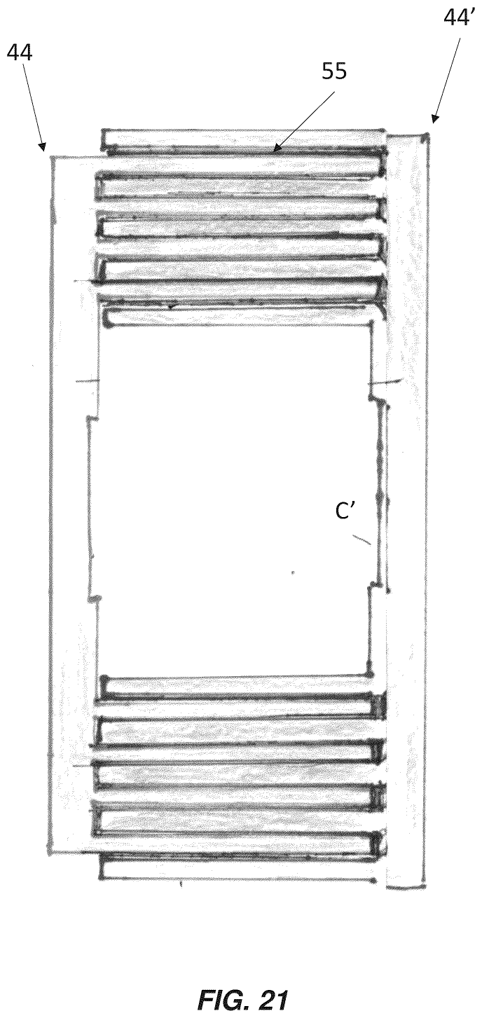

FIG. 21 shows an electromagnetic armature in which the first flux manifold 44 and the second flux manifold 44′ have been interdigitated with the rotor layer 55 being provided between them. Again, not shown, is an electrically insulating layer between the rotor layer 55 and the flux manifolds 44 and 44′. The layers may be adhered or bonded, perhaps by the insulating layer material.

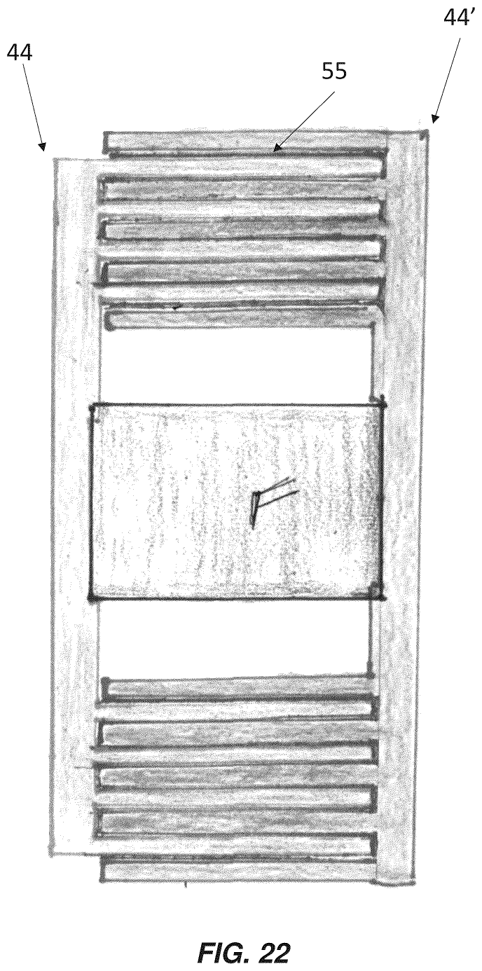

FIG. 22 shows an electromagnetic armature where the flux manifolds 44 and 44′ are indigitated with the rotor layer 55 therebetween. This arrangement further includes a centrally located axial magnet (F). The magnet (F) may be permanent, electric, or hybrid magnet. Here it is preferred that the magnet (F) is a ferrite cylinder. One pole of the magnet (F), magnetizes the first flux manifold 44 with, for example, north flux, while the second flux manifold 44′ is the south side. The flux travels from the north side of the magnet (F), into that manifold's side wall and into the stator layers. It crosses the rotor 55 and insulating layers in a radial fashion, traversing into the adjacent manifold's stator layers and back into the south pole end of the magnet (F). The whole device rotates monolithically about the central axis of the magnet in this conceptualization.

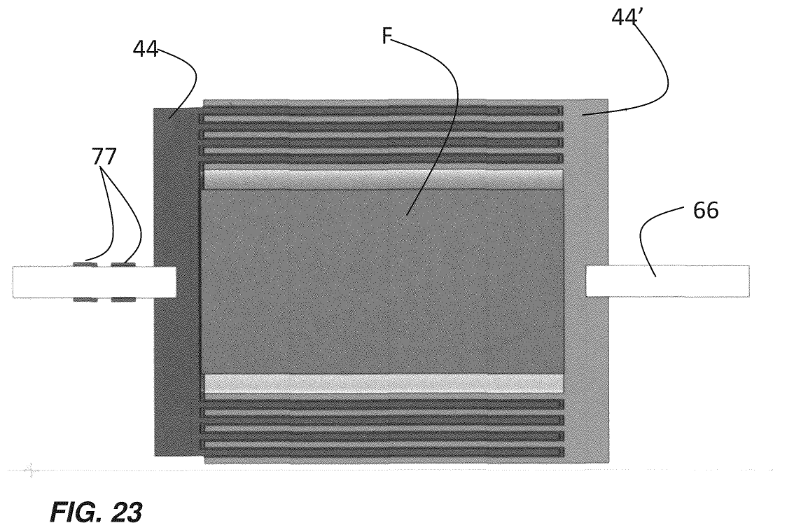

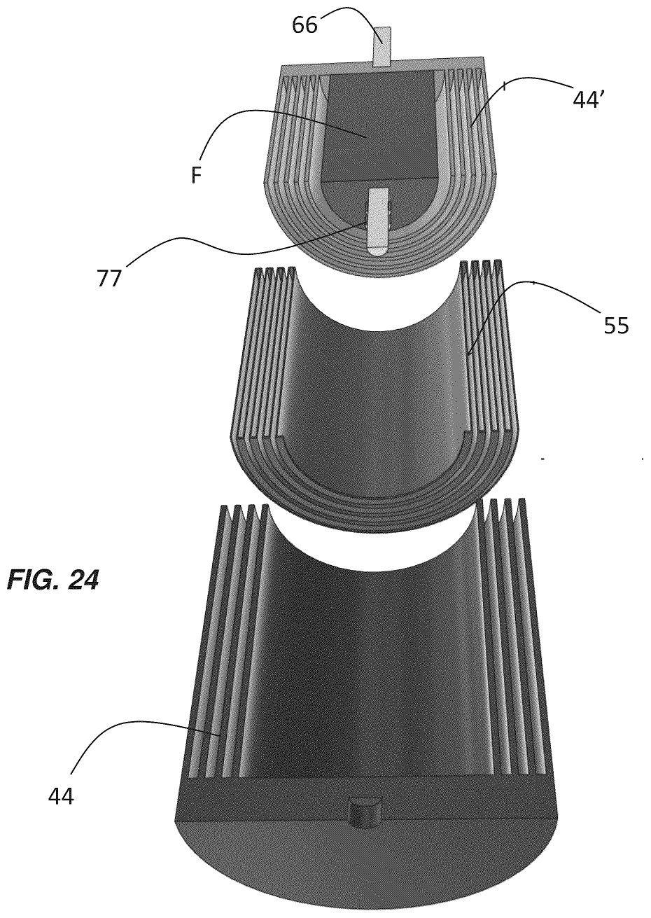

FIGS. 23-25 depict and example embodiment of a an electromagnetic armature with a thinner rotor layer and an axle. This example embodiment includes an added axial shafts 66 and current collectors 77. The axle may extend through the whole device as shown with the dashed lines in FIG. 24, but is more likely to just come off of the flux manifolds and not penetrate the center of the device. FIG. 24 also shows example locations for bearings (I) connected to the axle. Note that it is preferred that the bearings (I) are positioned outside of the generator proper where the bearings (I) can be serviced or replaced more easily than in conventional designs. The current created in the rotor layers is collected via wires (G) and sent to, in this case, slip rings (H). Alternatives for the slip rings include conductive bearings, slip tubes described in disclosures related to this application, and example embodiments including contactless inductive ‘contacts.’

Because the bearings are associated, but not integral to the generator apparatus, the entire generator apparatus is essentially integral in that it spins as one single assembly. Preferably, none of the parts of the electromagnetic armature move relative to the others. The radial magnetic fields do not rotate as described above. The rotor layers rotate through the stationary radial magnetic flux, transecting the lines of flux at 90 degrees throughout both their longitudinal length and throughout the full 360 degrees of their rotation so current is efficiently induced to flow. The efficiency of this Lorenz function is higher than with all conventional generators. In this example embodiment the voltage of each layer is additive as the layers are connected in series.

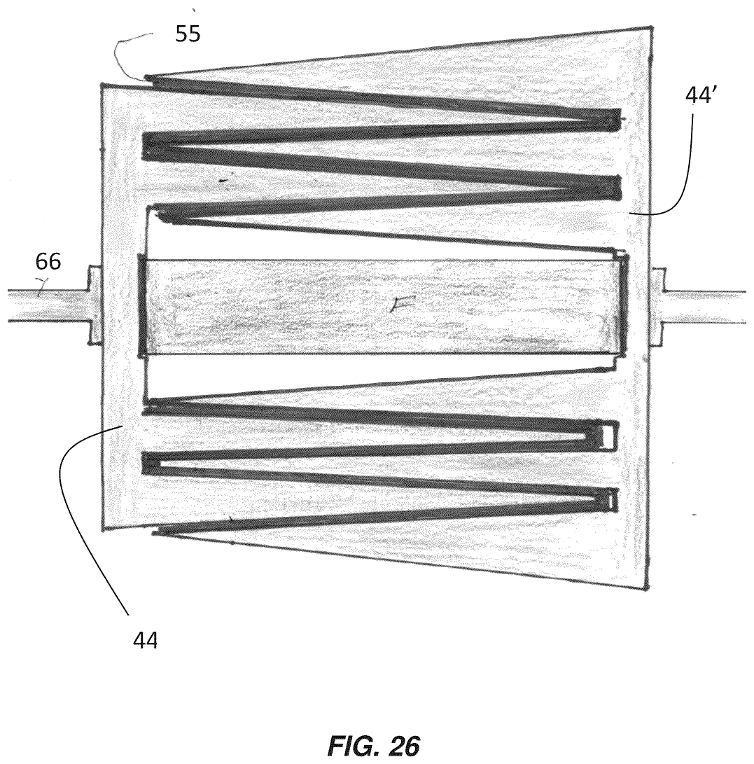

in the above-described Figures, there is a relative flux bottle neck where the flux traverses from the side walls to the stator layers. All the flux that exits the surface area of the surface of the stator layer has to enter through the cross sectional area of the base of that material so that it is able to saturate. Making that specific portion of the flux manifold thicker, as pictured in FIGS. 26-29 is one way to alleviate the issue.

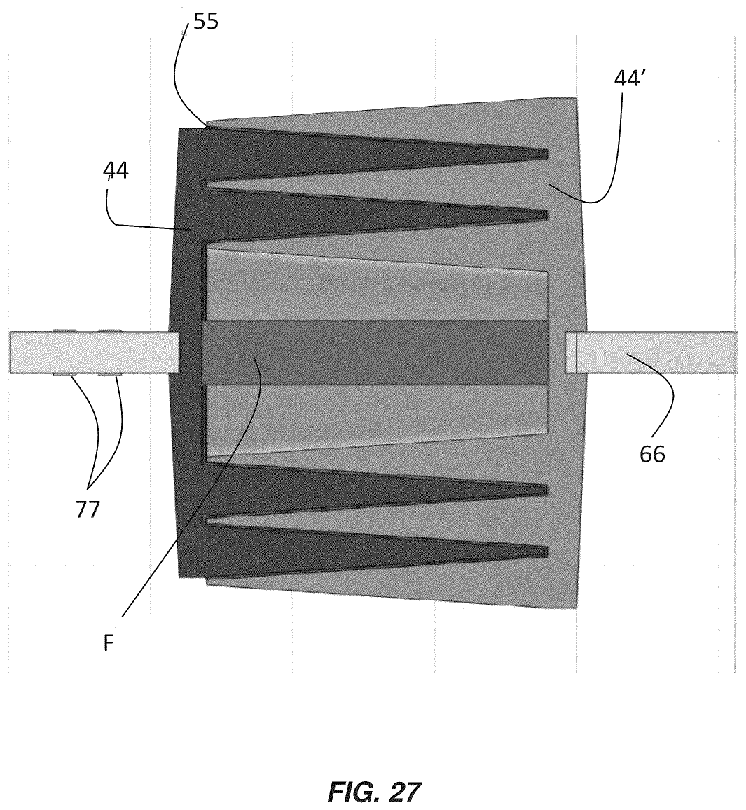

FIGS. 26 and 27 show an exaggerated tapering morphology of the cylindrical stator layers which can be used to improve the flow of flux. In FIG. 26, the side surfaces of the flux manifolds 44 and 44′ which are connected to the shafts are tapered such that the total axial thickness of the flux manifolds 44 and 44′ decreases as the flux manifolds 44 and 44′ extend radially outward.

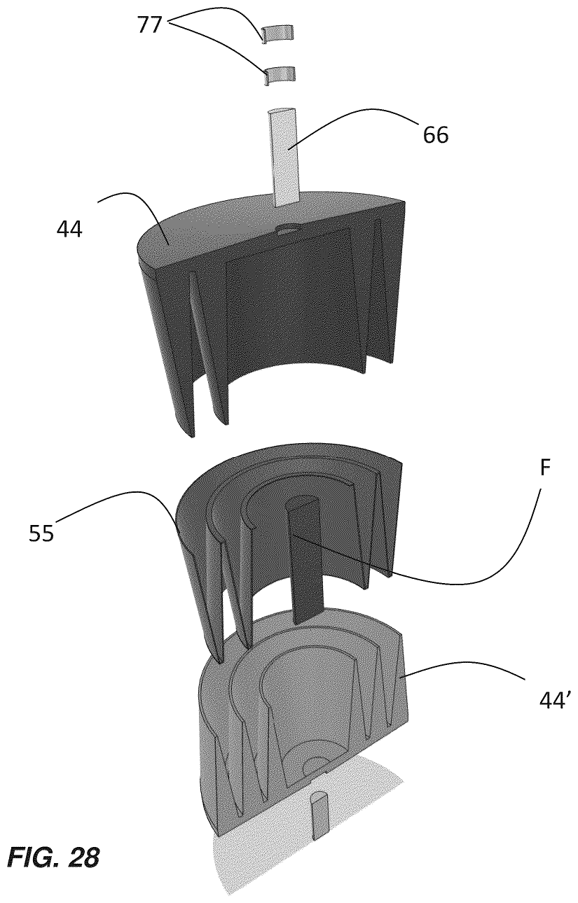

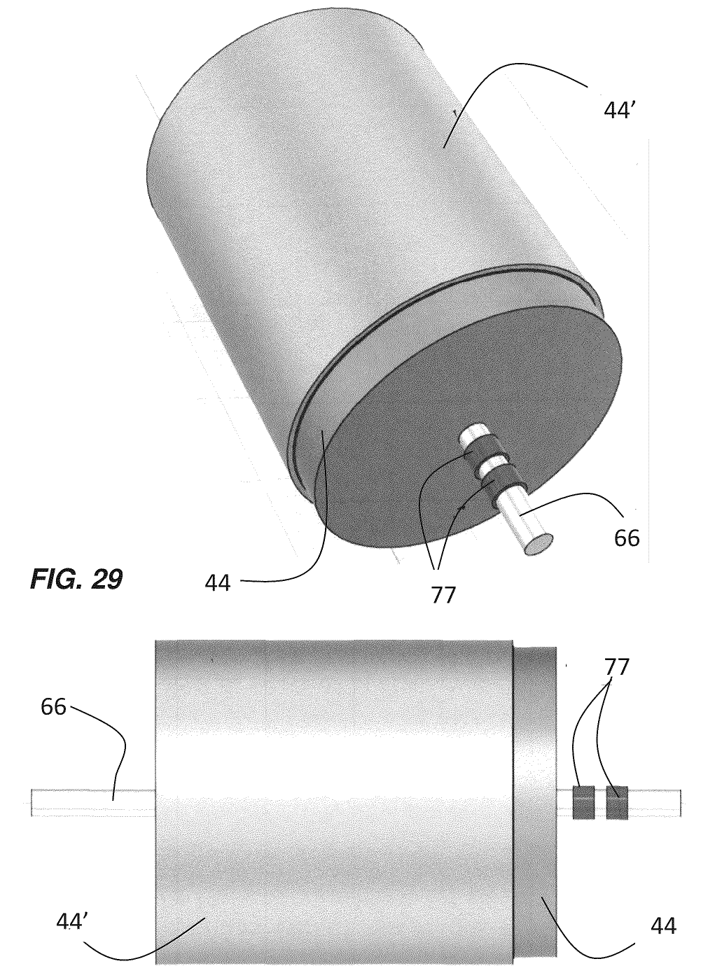

FIG. 28 depicts an exploded view of the electromagnetic armature showing the first flax manifold 44, the rotor layer 55 and the second flux manifold 44′. The added axial shafts 66 and the current collectors 77 are also shown. FIG. 29 shows external views of an assembled example of this embodiment.

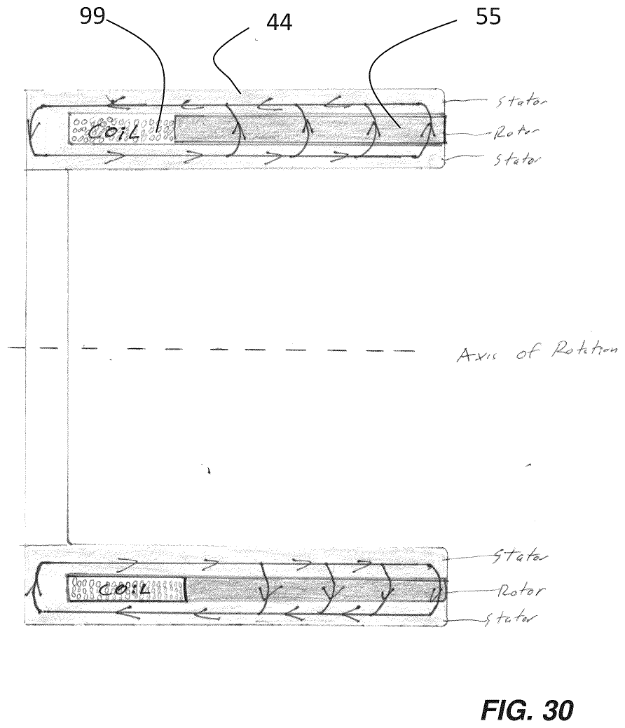

FIG. 30 shows a different version of the example embodiment in which flux is created by an electromagnet coil 99 that may be situated between projecting cylindrical layers of a stator 91, or which may be provided in an adjacent coil box that magnetically communicates with layers of the stator 91. In either case, the coil 99 wraps around one end of the inner stator layer and is contained on the outer periphery by the outer stator layer. The flux is made to flow within a three sided magnetically continuous structure with the rotor layer defining a fourth side. If the coil 99 is energized with AC current, the output from the electromagnetic armature is AC.

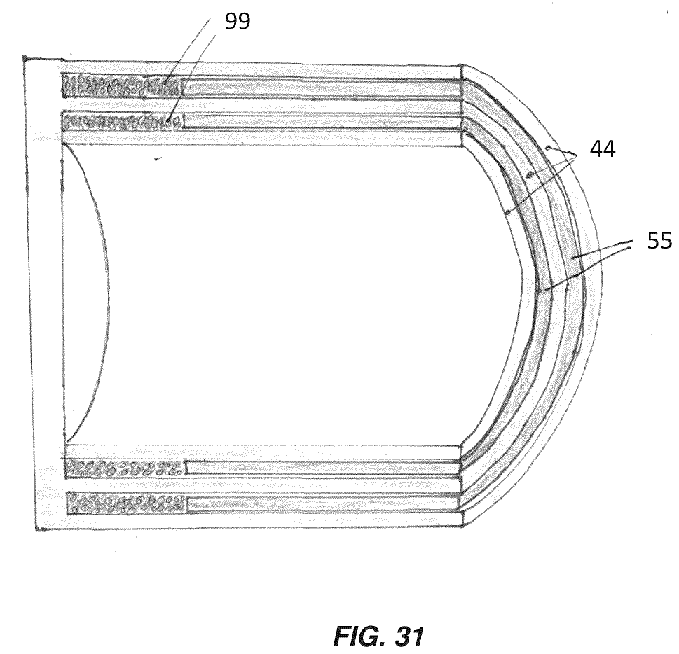

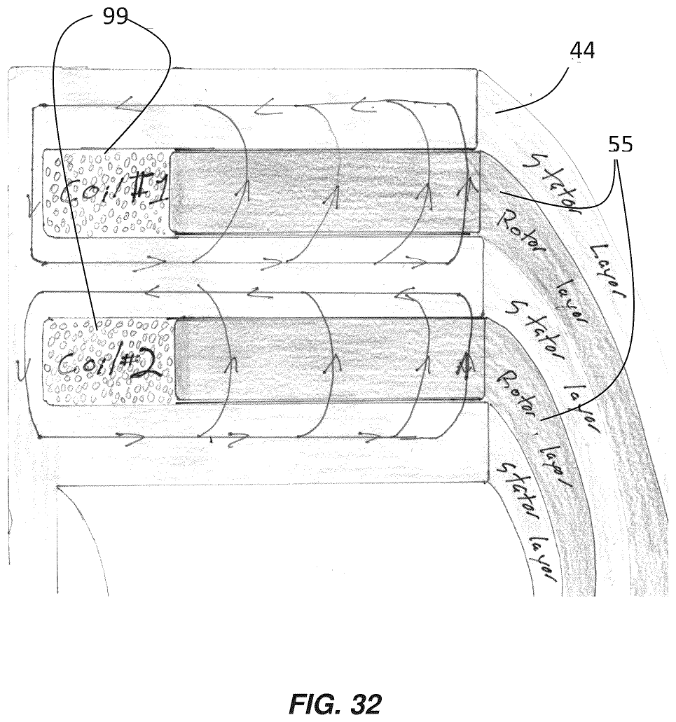

FIGS. 31 and 32 show an example embodiment which is similar to the device of FIG. 29 but which includes a stator 91′ with three cylindrical layers that are magnetized by two electromagnetic coils 99′. The 2 coils 99′ are wound and energized to provide the middle layer of the stator 91′ with the same polarity of flux, say north, while the inner and outer stator cylinders are magnetized with the opposite flux, say south. When the whole electromagnetic armature spins emf is produced in opposite directions because the flux is pointing opposite as it passes through each rotor layer.

FIG. 32 shows is a close up of one end of the stator/rotor armature showing the central stator layer can be magnetized simultaneously with both north and south flux from coils that are wound and energized to put both north and south flux into the central stator layer while putting north flux into one of the outer or inner layer with south flux going into the other. The emf generated in the rotor layers when this unit is spun in the same direction in contrast to FIG. 30. Surprisingly it has been discovered that the middle stator layer can handle both polarities of flux simultaneously.

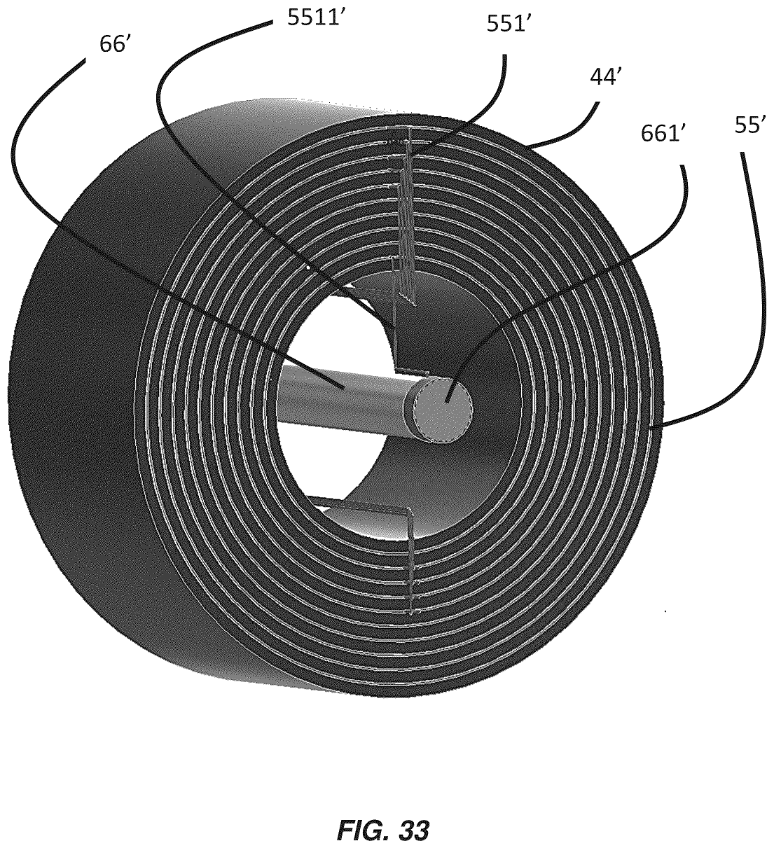

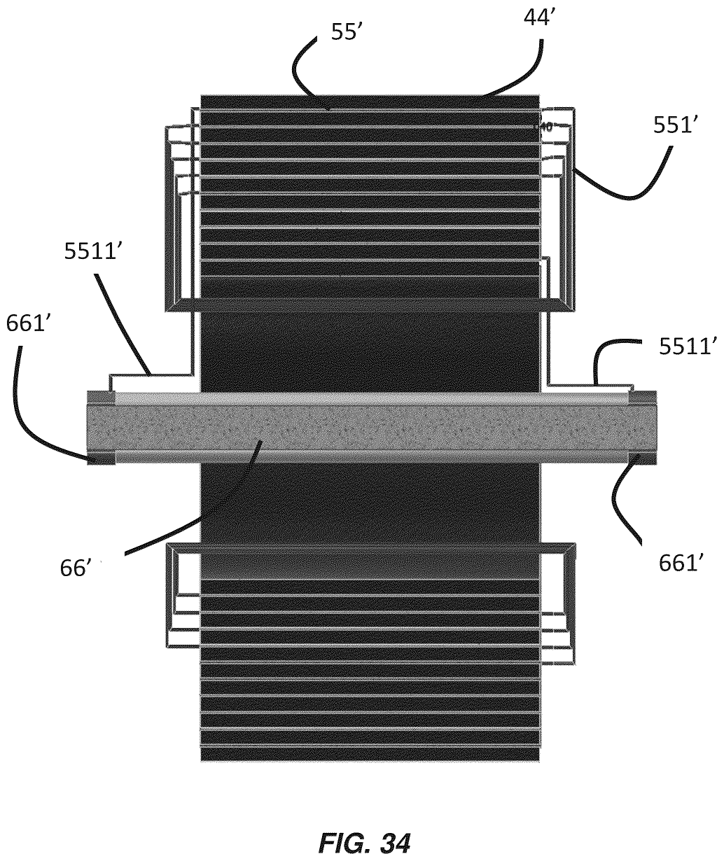

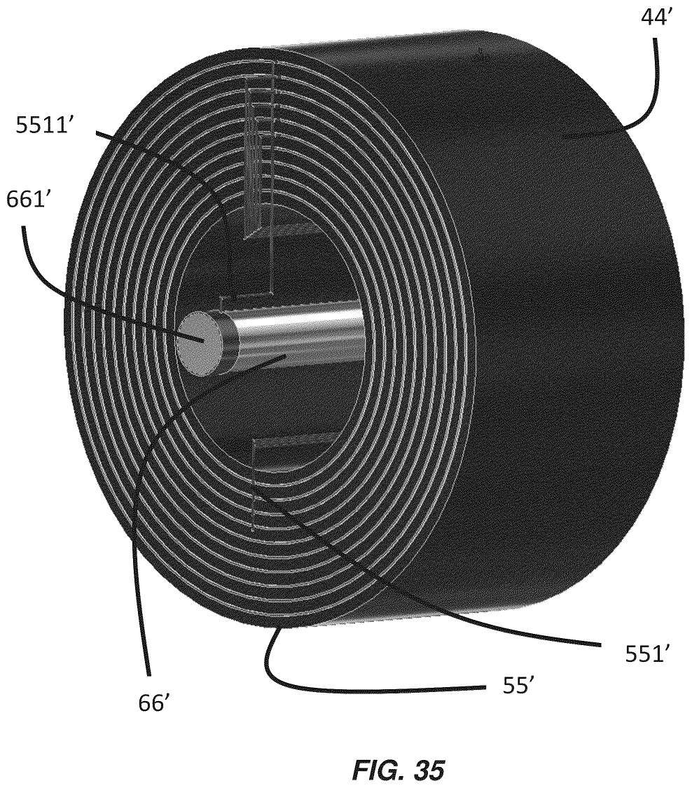

FIGS. 33-35 show internal components of an electromagnetic armature which rotates about an axis of a shaft 66′, the electromagnetic armature includes black concentrically arranged cylindrical stator magnetic layers 44′ all oriented with identical magnetic polarities in which either magnetic north is positioned radially outward or magnetic north is positioned radially inward in so that the voltage in the rotor layers 55′ is all induced in a same axial direction. Here, the rotor layers 55′ preferably include respective electrical conductor wires 551′ which connect, for example, a lower axial side of one rotor layer 55′ to an upper axial side of a different rotor layer 55′, so they are in series. The electrical conductor wires 551′ are all grouped and respectively connected to transmission lines 5511′ which are connected to collectors 661′ on the shaft 66′.

It is noted that other example embodiments of the present invention could include rotor layers 55′ connected in parallel with other rotor layers 55′ through respective electrical conductor wires 551′. Generally, series connections between the rotor layers 55′ provide an increased voltage output from the rotor layers 55′ through the electrical conductor wires 551′ while parallel connections between the rotor layers 55′ provide an increased amperage output from the rotor layers 55′ through the electrical conductor wires 551′. Note that it is also possible to create two or more groups of electrically connected rotor layers 55′, with the electrically connected rotor layers 55′ of the two or more groups being connected in series, and the two or more groups themselves being electrically connected in parallel. It is also possible to provide a series connected arrangement of two or more groups of electrically connected rotor layers 55′, with the electrically connected rotor layers 55′ of the two or more groups being connected in parallel. Accordingly, it is possible to specifically tailor a voltage and amperage output of the rotor by selectively connecting groups of the rotor layers 55′ in series/parallel.

As described in the earlier applications which have been incorporated herein by reference, the magnetization strength can be made adjustable via electromagnets or hybrid electro/permanent magnets to allow the generator/motor to tune itself to be maximally efficient or powerful in the variable operating conditions that are represented especially clearly by wind power and electric vehicle applications. The concentric nature of the layers also contribute to the intrinsic and automatic adaptability in the manner described in the earlier applications which have been incorporated herein by reference. In brief, assuming equal magnetization of all layers, those layers with a wider diameter travel the fastest and further per revolution compared to the layers closer to the center that have smaller diameters. As such, per revolution, they cut through more lines of flux. This causes them to cut in or ramp up power or torque production first. This makes to machine more intrinsically adaptable. In the example of a generator, the faster it spins the more layers reach the higher parts of their asymptotic/logarithmic output curves, so the faster it spins the more generating capacity is automatically recruited.

The generators and motors described herein utilize physical properties to allow the physical stator and rotor layers to rotate together. This allows the layers to be adhered or fit together to share structural integrity, in turn allowing thinner layers. This in turn further permits:

The ability to combine the rotor layers in strategic patterns of series and parallel electrical connections so as to manufacture a rotor with the correct voltage/amperage output and thereby solve a problem of the conventional homopolar structures. This also allows less demand on the power conditioning balance of a power plant.

Allowing the stator layers to be energized via AC electromagnets, creating an AC output which solves the other main issue holding back conventional homopolar structures.

The magnets that are electro magnets or electro permanent magnets can have adjustable field intensity allowing for control, braking, and adaptability to variable operating conditions and demands.

Less demand for rare earth magnets.

More efficient motors.

Less expensive, more power-dense and easier to build electrical machines that last longer and have all wear items moved out of the unit.

Integral structure means less breakdowns.

Bearing and current collectors are the only wear items and are provided on the outside where it is easier to maintain.

Can be structured to require less gear box ratio and even no gearbox so as to require many fewer parts.

Permutation, to a degree, the stator layers can function as the rotor layers.

In some example embodiments, the stator layers themselves can function weakly as the rotor if they are separated by an insulation layer, but the volume of the rotor layer stretches out the radial part of the flux, making it much more advantageous to have a rotor layer.

It should be understood that the foregoing description is only illustrative of example embodiments of the present invention. Various alternatives and modifications can be devised by those skilled in the art without departing from the present invention. Accordingly, the present invention is intended to embrace all such alternatives, modifications, and variances that fall within the scope of the appended claims.

What is claimed is:

1. An electromagnetic armature comprising:
electrically connected rotor layers; and
stator layers made of magnetically permeable material; wherein
the rotor layers are provided radially between adjacent ones of the stator layers; and
the rotor layers and the stator layers are integrally connected to rotate together about a central axis of the electromagnetic armature.

2. The electromagnetic armature according to claim 1, wherein the rotor layers are electrically connected to one other in series by alternating axial ends of the rotor layers being electrically connected together.

3. The electromagnetic armature according to claim 1, wherein the stator layers are cylindrical stator layers which include portions of a first stator which are connected together through a first disk-shaped side wall on one axial end of the electromagnetic armature.

4. The electromagnetic armature according to claim 3, further comprising:
a second stator including cylindrical stator layers which are connected together through a second disk-shaped side wall on a second axial end of the electromagnetic armature; wherein
the rotor layers are provided directly radially between adjacent ones of the cylindrical stator layers of the first stator and the cylindrical stator layers of the second stator.

5. The electromagnetic armature according to claim 4, further comprising:
at least one axial shaft rotatably supporting the electromagnetic armature.

6. The electromagnetic armature according to claim 5, wherein
the at least one axial shaft includes two axial shafts, one of the two axial shafts is affixed to the first disk-shaped side wall and another one of the two axial shafts is affixed to the second disk-shaped side wall.

7. The electromagnetic armature according to claim 5, further comprising:
at least one current collector electrically connected to the rotor layers and is provided on the at least one axial shaft.

8. The electromagnetic armature according to claim 4, further comprising:
a magnet extending axially between the first stator and the second stator and contacting both of the first disk-shaped side wall and the second disk-shaped side wall.

9. The electromagnetic armature according to claim 8, further comprising:
an axial shaft rotatably supporting the electromagnetic armature; wherein
the axial shaft extends through an opening which passes through the magnet.

10. The electromagnetic armature according to claim 3, wherein
the cylindrical stator layers are defined by concentric ring-shaped projections which extend out from the first disk-shaped side wall, the concentric ring-shaped projections being centered around the central axis of the electromagnetic armature; and
a recess is located in an axially upper surface of the first disk-shaped side wall at a position radially inward from the concentric ring-shaped projections.

11. The electromagnetic armature according to claim 10, further comprising:
a magnet including a portion supported by the recess in the axially upper surface of the first disk-shaped side wall.

12. The electromagnetic armature according to claim 1,
wherein the stator layers have radial thicknesses that vary as the stator layers extend in the axial direction.

13. The electromagnetic armature according to claim 12, wherein
the stator layers include portions of a first stator connected together through a first disk-shaped side wall on one axial end of the electromagnetic armature.

14. The electromagnetic armature according to claim 13, further comprising:
a second stator including stator layers connected together through a second disk-shaped side wall on a second axial end of the electromagnetic armature; wherein
the stator layers of the second stator have radial thicknesses that vary as the stator layers extend in the axial direction; and
the rotor layers are provided directly radially between adjacent pairs of the stator layers of the first stator and the stator layers of the second stator.

15. The electromagnetic armature according to claim 1, further comprising:
at least one electromagnetic coil provided radially between the adjacent pairs of the stator layers.

16. The electromagnetic armature according to claim 15, further comprising:
an additional electromagnetic coil provided radially between another adjacent pair of the stator layers.

17. The electromagnetic armature according to claim 1, wherein two stator layers are provided directly adjacent to one another in the radial direction without any portion of the rotor layers being provided between the two stator layers.

18. The electromagnetic armature according to claim 1, wherein the rotor layers are electrically connected to one other in parallel by adjacent axial ends of the rotor layers being electrically connected together.

19. The electromagnetic armature according to claim 1, wherein the adjacent pairs of the stator layers include a north pole stator layer and a south pole stator layer.

20. A dynamoelectric machine including:
a stator;
a rotor;
a shaft; and
current collectors; wherein
the stator includes multiple concentrically arranged cylindrical stator layers;
the rotor includes multiple concentrically arranged cylindrical rotor layers;
each of the multiple concentrically arranged cylindrical rotor layers is located between adjacent pairs of the concentrically arranged cylindrical stator layers;
the stator and the rotor are affixed to one another and are rotatable together about a central axis of the shaft; and
each of the concentrically arranged cylindrical stator layers have identical magnetic polarities.
